(19) United States
(12) Patent Application Publication
(10) Pub. No.: US 2026/0110985 A1
(43) Pub. Date: Apr. 23, 2026

(54) PROCESS CARTRIDGE

(71) Applicant: CANON KABUSHIKI KAISHA, Tokyo (JP)

(72) Inventors: KODAI HAYASHI, Shizuoka (JP); KEITARO NAKATA, Shizuoka (JP); MASATAKE TANAKA, Kanagawa (JP); TAIJI KATSURA, Shizuoka (JP)

(21) Appl. No.: 19/424,389

(22) Filed: Dec. 18, 2025

Related U.S. Application Data
(63) Continuation of application No. PCT/JP2024/011979, filed on Mar. 26, 2024.

(30) Foreign Application Priority Data
Jun. 23, 2023 (JP) 2023-103626

(51) Int. Cl. G03G 21/18; G03G 9/08

(52) U.S. Cl. CPC G03G 21/1814; G03G 9/0819; G03G 21/1825; G03G 21/186

(57) ABSTRACT

This disclosure describes a cartridge that includes a photosensitive drum, a development roller, a supply roller, a development chamber, a development blade with an elastic component, and a toner accommodation section. The accommodation section and development chamber are in mutual communication. Blade contact with the development roller is below its horizontal centerline. The toner, with particle diameter R, contains fluorine-enriched hydrotalcite particles as an external additive. The text specifies critical geometric relationships between the elastic blade and the development roller at their nip. Using multiple defined reference points (D, B, E, F, G) to describe this configuration, a crucial condition is stated: the distance between points G and F must be at least R.

### CROSS-REFERENCE TO RELATED APPLICATIONS

This application is a Continuation of International Patent Application No. PCT/JP2024/011979, filed Mar. 26, 2024, which claims the benefit of Japanese Patent Application No. 2023-103626, filed Jun. 23, 2023, both of which are hereby incorporated by reference herein in their entirety.

### BACKGROUND

### Field of the Technology

The present disclosure relates to a process cartridge.

### Description of the Related Art

In an image forming apparatus such as a printer using an electrophotographic image forming method (electrophotographic process), an electrophotographic photoreceptor (hereinafter, referred to as a “photoreceptor”) as an image carrier is uniformly charged, and the charged photoreceptor is selectively exposed to light to form an electrostatic image on the photoreceptor. The electrostatic image formed on the photoreceptor is visualized as a toner image with toner as a developer. Then, the toner image formed on the photoreceptor is transferred to a recording material such as a recording sheet or a plastic sheet, and heat or pressure is applied to the toner image transferred onto the recording material to fix the toner image to the recording material, thereby performing image recording.

Such an image forming apparatus generally requires replenishment of a developer and maintenance of various process units. In order to facilitate the developer replenishing operation and the maintenance of various process units, a process cartridge in which a photoreceptor, a charging unit, a developing unit, a cleaning unit, and the like are collectively disposed in a frame body to form a cartridge and the cartridge is detachably attached to an image forming apparatus main body has been put into practical use. According to a process cartridge method, an image forming apparatus having excellent usability can be provided.

In recent years, a color image forming apparatus that forms a color image using developers of a plurality of colors has become widespread. As the color image forming apparatus, a so-called in-line method image forming apparatus is known in which photoreceptors respectively corresponding to image forming operations using developers of a plurality of colors are arranged in a line in a surface moving direction of a transferred body to which a toner image is transferred. As the in-line method color image forming apparatus, there is an in-line method color image forming apparatus in which a plurality of photoreceptors are arranged in a line in a direction (for example, a horizontal direction) intersecting with a vertical direction (gravity direction). The in-line method is a preferable image forming method in terms of easy response to demands such as an increase in image forming speed and development in a multifunction printer.

In addition, as the image forming apparatus, there is an image forming apparatus in which a photoreceptor is disposed below an intermediate transfer body as a transferred body or a recording material carrier that conveys a recording material as a transferred body (Japanese Patent Laid-Open No. 2011-253203).

When the photoreceptor is disposed below an intermediate transfer body or a recording material carrier, for example, a fixing device and a developing device (or an exposure device) can be disposed away from each other in a mode in which the intermediate transfer body or the recording material carrier is sandwiched between the fixing device and the developing device in an image forming apparatus main body. Therefore, there is an advantage that the developing device (or the exposure device) is hardly affected by heat of the fixing device.

### SUMMARY

The present disclosure is directed to provide a cartridge further developed from a conventional cartridge.

The present disclosure has the following configuration. That is, a process cartridge attachable to an image forming apparatus, including:
a photosensitive drum which is an image carrier; a developing roller that develops a toner image on the photosensitive drum;
a supply roller that supplies toner to the developing roller;
a developing chamber having a support portion pivotally supporting the developing roller and the supply roller;
a developing blade that regulates a layer thickness of toner on the developing roller;
toner including toner particles having a volume average particle size R and an external additive; and
a toner storage storing the toner,
the toner storage communicating with the developing chamber via a communication port,
a moving direction of a surface of the developing roller being opposite to a moving direction of a surface of the supply roller at a contact position with the supply roller,
in a cross section of the process cartridge in a plane perpendicular to a rotation shaft of the developing roller in an attached state of being attached to an apparatus main body of the image forming apparatus, a portion where the developing blade comes into contact with the developing roller being vertically below a horizontal line H1 passing through the rotation shaft center of the developing roller,
the process cartridge further including:
a driving force receiving portion;
a first driving force transmitting portion that transmits a driving force from the driving force receiving portion to the supply roller;
a second driving force transmitting portion that is disposed in the supply roller and transmits a driving force received by the first driving force transmitting portion to the developing roller; and
a third driving force transmitting portion that is disposed in the developing roller and transmits a driving force from the second driving force transmitting portion to the developing roller, wherein
the toner includes hydrotalcite particles as the external additive,
fluorine is present inside the hydrotalcite particles in line analysis in STEM-EDS mapping analysis of the toner,
the developing blade includes a plate-shaped metal elastic blade and a blade support portion supporting the elastic blade,
in a cross section of the process cartridge in a plane perpendicular to a rotation shaft of the developing roller,
the elastic blade forms a nip N1 with the developing roller and is in contact with the developing roller,
a point at an end portion on an upstream side in a rotation direction of the developing roller in the nip N1 on the elastic blade is defined as a point D,
a point which is closest to a free end side of the elastic blade and closest to a surface of the developing roller is defined as a point B,
a point where a perpendicular line extending from the point B to the surface of the developing roller intersects with the surface of the developing roller is defined as E,
there is a point F which is a point on a surface of the elastic blade whose distance from the surface of the developing roller is R and closest to the free end side of the elastic blade, and
when a point on a straight line BE at which a distance from the surface of the developing roller is R is defined as G, a distance of GF is R or more.

The present disclosure also has the following configuration. That is, a process cartridge attachable to an image forming apparatus, including:
a photosensitive drum which is an image carrier; a developing roller that develops a toner image on the photosensitive drum;
a supply roller that supplies toner to the developing roller;
a developing chamber having a support portion pivotally supporting the developing roller and the supply roller;
a developing blade that regulates a layer thickness of toner on the developing roller;
toner including toner particles having a volume average particle size R and an external additive; and
a toner storage storing the toner,
the toner storage communicating with the developing chamber via a communication port,
a moving direction of a surface of the developing roller being opposite to a moving direction of a surface of the supply roller at a contact position with the supply roller,
the developing blade including a plate-shaped metal elastic blade and a blade support portion supporting the elastic blade,
in a cross section of the process cartridge in a plane perpendicular to a rotation shaft of the developing roller,
in a cross section of the process cartridge in a plane perpendicular to a rotation shaft of the developing roller,
in a posture in which a straight line A connecting rotation centers of the supply roller and the developing roller is inclined by about 9.85° from horizontal, a rotation shaft center of the supply roller is located below a rotation shaft center of the developing roller, and a rotation shaft center of the photosensitive drum is located above the straight line A, a portion where the elastic blade comes into contact with the developing roller being located below the rotation shaft center of the developing roller,
the process cartridge further including:
a driving force receiving portion;
a first driving force transmitting portion that transmits a driving force from the driving force receiving portion to the supply roller;
a second driving force transmitting portion that is disposed in the supply roller and transmits a driving force received by the first driving force transmitting portion to the developing roller; and
a third driving force transmitting portion that is disposed in the developing roller and transmits a driving force from the second driving force transmitting portion to the developing roller, wherein
the toner includes hydrotalcite particles as the external additive,
fluorine is present inside the hydrotalcite particles in line analysis in STEM-EDS mapping analysis of the toner,
in a cross section of the process cartridge in a plane perpendicular to the rotation shaft of the developing roller,
the elastic blade forms a nip N1 with the developing roller and is in contact with the developing roller,
a point at an end portion on an upstream side in a rotation direction of the developing roller in the nip N1 on the elastic blade is defined as a point D,
a point which is closest to a free end side of the elastic blade and closest to a surface of the developing roller is defined as a point B,
a point where a perpendicular line extending from the point B to the surface of the developing roller intersects with the surface of the developing roller is defined as E,
there is a point F which is a point on a surface of the elastic blade whose distance from the surface of the developing roller is R and closest to the free end side of the elastic blade, and
when a point on a straight line BE at which a distance from the surface of the developing roller is R is defined as G, a distance of GF is R or more.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view of an image forming apparatus according to Example to which the present disclosure is applicable.

FIG. 2 is a schematic cross-sectional view of a process cartridge according to Example to which the present disclosure is applicable.

FIG. 3 is a conceptual cross-sectional view in a short direction of a developing blade according to Example to which the present disclosure is applicable.

FIG. 4A is a cross-sectional conceptual diagram for explaining a contact state between a developing blade and a developing roller according to Example to which the present disclosure is applicable.

FIG. 4B is a cross-sectional conceptual diagram for explaining a contact state between a developing blade and a developing roller according to Comparative Example of the present disclosure.

FIG. 5 is a diagram for explaining a drive input method to a toner supply roller according to Example to which the present disclosure is applicable.

FIG. 6 is a diagram illustrating movement of toner in a developing device according to Example to which the present disclosure is applicable.

FIG. 7 is a diagram for explaining a positional relationship between an inner wall of a developing chamber and a support end of a developing blade according to Example to which the present disclosure is applicable.

FIG. 8A is a cross-sectional conceptual diagram of a contact portion between a developing roller and a developing blade according to Example to which the present disclosure is applicable for explaining movement of toner regulated by the developing blade.

FIG. 8B is a cross-sectional conceptual diagram of a contact portion between a developing roller and a developing blade according to Example to which the present disclosure is applicable for explaining movement of toner regulated by the developing blade.

FIG. 9A is a schematic diagram of line analysis of an external additive.

FIG. 9B is a schematic diagram of line analysis of an external additive.

FIG. 9C is a schematic diagram of line analysis of an external additive.

FIG. 10 is a cross-sectional conceptual diagram of a developing blade in a short direction when a distal end of a developing blade is bent in a modification of Example to which the present disclosure is applicable.

### DESCRIPTION OF THE EMBODIMENTS

Hereinafter, a developing device, a process cartridge, and an image forming apparatus according to the present disclosure will be described in more detail with reference to the drawings. Note that the dimensions, materials, shapes, relative arrangements, and the like of components described in the embodiment are not intended to limit the scope of the present disclosure only to them unless otherwise specified. In addition, materials, shapes, and the like of members once described in the following description are similar to those in first description in later description unless otherwise specified. Well-known techniques or known techniques in the art are applicable to configurations and steps that are not particularly illustrated or described. Redundant description may be omitted.

### EXAMPLE

### [Image Forming Apparatus]

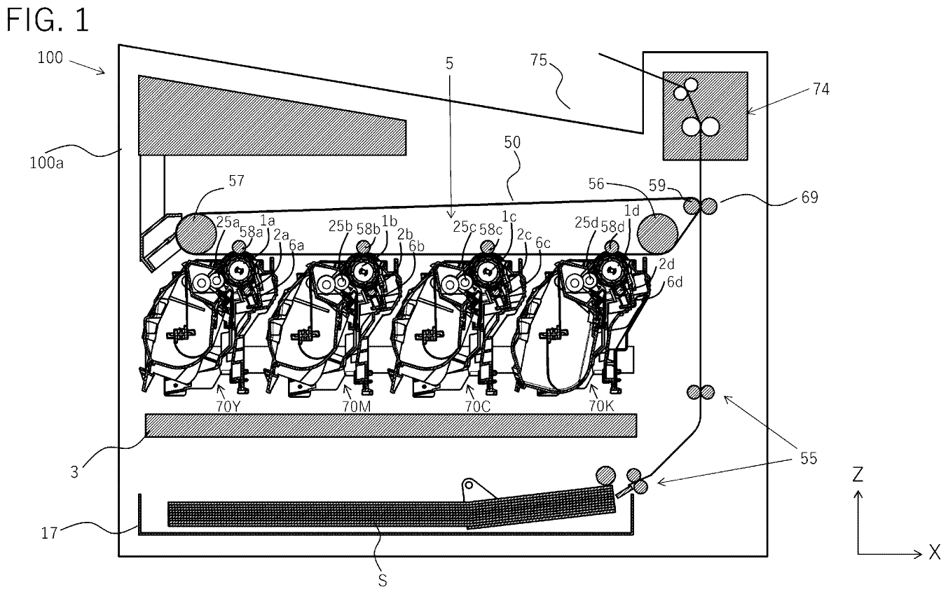

FIG. 1 is a diagram illustrating a schematic configuration in a posture where an image forming apparatus 100 of the present Example is left to stand on a horizontal plane similarly to the image forming apparatus 100 actually used. The image forming apparatus 100 of the present Example is a full-color laser printer adopting an in-line method and an intermediate transfer method. As illustrated in FIG. 1, four detachable process cartridges 70 (70Y, 70M, 70C, 70K) are attached by an attachment member (not illustrated). In addition, an upstream side in an attachment direction of the process cartridge 70 to the image forming apparatus 100 is defined as a front surface side, and a downstream side in the attachment direction is defined as a back surface side.

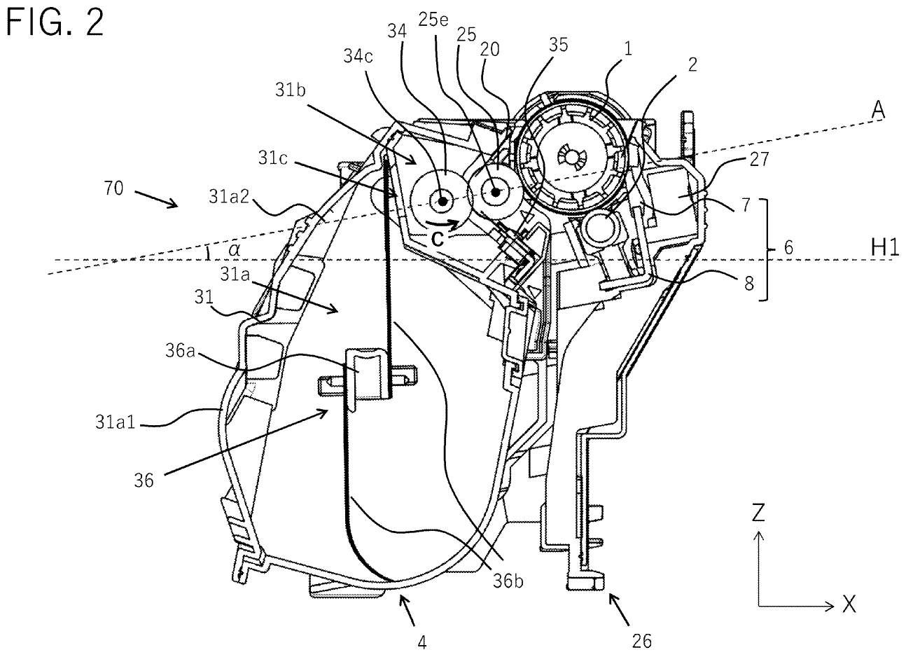

An electrophotographic photosensitive drum (hereinafter, referred to as a photosensitive drum) 1 (1a, 1b, 1c, 1d) is disposed in each process cartridge 70. In each process cartridge 70, process units such as a charging roller 2 (2a, 2b, 2c, 2d), a developing roller 25 (25a, 25b, 25c, 25d), and a cleaning member 6 (6a, 6b, 6c, 6d) are integrally disposed around the photosensitive drum 1. The charging roller 2 uniformly charges a surface of the photosensitive drum 1. In the present Example, the charging roller 2 charges the surface of the photosensitive drum 1 to a negative polarity. The developing roller 25 develops a latent image formed on the photosensitive drum 1 with a developer (hereinafter, referred to as toner) to make the latent image visible. A normal polarity of the toner of the present Example is a negative polarity. The cleaning member 6 removes the toner remaining on the photosensitive drum 1 after the toner image formed on the photosensitive drum 1 is transferred to a recording medium. More detailed configurations of the photosensitive drum 1, the charging roller 2, the developing roller 25, and the cleaning member 6 and a positional relationship therebetween will be described later with reference to FIG. 2.

In addition, a scanner unit 3 that selectively exposes the photosensitive drum 1 to light on the basis of image information to form a latent image on the photosensitive drum 1 is disposed below the process cartridge 70 in a direction of gravity.

A cassette 17 storing a recording medium S is attached to a lower portion of an apparatus main body 100a. A recording medium conveying unit is disposed such that the recording medium S passes through a secondary transfer roller 69 and a fixing unit 74 and is conveyed to an upper side of the apparatus main body 100a. An intermediate transfer unit 5 as an intermediate transfer unit that transfers a toner image formed on each photosensitive drum 1 (1a, 1b, 1c, 1d) is disposed above the process cartridge 70 (70Y, 70M, 70C, 70K). The intermediate transfer unit 5 includes a driving roller 56, a driven roller 57, a primary transfer roller 58 (58a, 58b, 58c, 58d) at a position facing the photosensitive drum 1 of each color, and a counter roller 59 at a position facing the secondary transfer roller 69, and a transfer belt 50 is stretched around the intermediate transfer unit 5. The transfer belt 50 circulates so as to face and come into contact with all the photosensitive drums 1, and performs primary transfer from the photosensitive drum 1 onto the transfer belt 50 by application of a voltage to the primary transfer roller 58 (58a, 58b, 58c, 58d). Then, the toner of the transfer belt 50 is transferred to the recording medium S by application of a voltage to the counter roller 59 and the secondary transfer roller 69 disposed in the transfer belt 50.

At the time of image formation, each photosensitive drum 1 is rotated, and the photosensitive drum 1 uniformly charged by the charging roller 2 is selectively exposed to light by the scanner unit 3. As a result, an electrostatic latent image is formed on the photosensitive drum 1. The latent image is developed by the developing roller 25. As a result, toner images of colors are formed on the photosensitive drums 1, respectively. In synchronization with this image formation, a resist roller pair 55 conveys the recording medium S to a secondary transfer position where the counter roller 59 and the secondary transfer roller 69 are in contact with each other with the transfer belt 50 interposed therebetween. Then, by application of a transfer bias voltage to the secondary transfer roller 69, the toner images of the colors on the transfer belt 50 are secondarily transferred to the recording medium S. As a result, a color image is formed on the recording medium S. The recording medium S on which the color image is formed is heated and pressurized by the fixing unit 74, and the toner image is fixed. Thereafter, the recording medium S is discharged to a discharge unit 75 by a discharge roller 72. Note that the fixing unit 74 is disposed in an upper portion of the apparatus main body 100a.

### [Process Cartridge]

Next, the process cartridge 70 embodying the present disclosure will be described with reference to FIG. 2. FIG. 2 illustrates a main cross section of the process cartridge 70 storing toner in a posture of being attached to the image forming apparatus 100. Note that the cartridge 70Y storing a yellow toner, the cartridge 70M storing a magenta toner, the cartridge 70C storing a cyan toner, and the cartridge 70K storing a black toner have the same configuration.

The process cartridge 70 includes a cleaning unit 26 and a developing unit 4. The cleaning unit 26 includes the photosensitive drum 1, the charging roller 2, and the cleaning member 6. The developing unit 4 includes the developing roller 25.

As described above, the charging roller 2 and the cleaning member 6 are disposed on a circumference of the photosensitive drum 1. The cleaning member 6 includes an elastic member 7 made of a rubber blade and a cleaning support member 8. A distal end portion of the elastic member 7 made of a rubber blade is disposed in contact with the photosensitive drum 1 in a counter direction with respect to a rotation direction of the photosensitive drum 1. A residual toner removed from a surface of the photosensitive drum 1 by the cleaning member 6 falls into a removed toner chamber 27.

By transmitting a driving force of a main body driving motor (not illustrated) as a driving source to the cleaning unit 26, the photosensitive drum 1 is rotationally driven according to an image forming operation. At this time, a drum coupling fixed to a longitudinal end portion of the photosensitive drum 1 and a main body side coupling present on a longitudinal axis of the photosensitive drum 1 are engaged with each other, whereby the driving force is input to the photosensitive drum 1. The charging roller 2 is rotatably attached to the cleaning unit 26 via a charging roller bearing, is pressurized toward the photosensitive drum 1 by a charging roller pressurizing member, and rotates following the photosensitive drum 1.

The developing unit 4 includes the developing roller 25 that rotates in contact with the photosensitive drum 1, and a developing frame body 31 supporting the developing roller 25. The developing frame body 31 includes a developing chamber 31b and a toner storing chamber 31a (toner storage).

On a circumference of the developing roller 25, a toner supply roller 34 that rotates in a direction of arrow C in contact with the developing roller 25 and a developing blade 35 that regulates a toner layer on the developing roller 25 are disposed. In the present Example, an outer diameter of the developing roller 25 is 12 mm, and an outer diameter of the toner supply roller 34 is 13.2 mm. In a posture in which the process cartridge 70 is attached to the image forming apparatus 100, an angle α formed by a horizontal line H and a straight line A connecting a rotation center 25e of the developing roller 25 and a rotation center 34e of the toner supply roller 34 is 9.85 degrees. Note that the angle α is not limited thereto.

By transmitting a driving force of a main body driving motor (not illustrated) different from the driving source of the cleaning unit to the developing unit 4, the developing roller 25 and the toner supply roller 34 are rotationally driven according to an image forming operation. A method for inputting the driving force is a drive input via a coupling similarly to the cleaning unit 26, and details thereof will be described later. The drive input method with the coupling is preferable from a viewpoint of rotational stability as compared with a drive input via a gear.

The developing roller 25 is an elastic roller in which a conductive elastic rubber layer having a predetermined volume resistance as an elastic layer is disposed around a metal core. The developing roller 25 includes a base layer and a surface layer. Silicone rubber is used for the base layer, urethane rubber is used for the surface layer, particles of urethane beads are dispersed in the urethane rubber of the surface layer, and a desired roughness is set. The developing roller 25 and the photosensitive drum 1 rotate such that surfaces thereof move in the same direction (a direction from bottom to top in the present Example) at a facing portion (contact portion). In the present Example, toner negatively charged by frictional charging with respect to a predetermined DC bias applied to the developing roller 25 is transferred only to a bright part potential portion due to a potential difference thereof in a developing portion in contact with the photosensitive drum 1 to visualize an electrostatic latent image.

The developing blade 35 is disposed below the developing roller 25, is in contact with the developing roller 25 in a counter, regulates a coating amount of toner supplied by the toner supply roller 34, and charges the toner. In the present Example, the developing blade 35 includes a flexible plate-shaped member and a developing blade 35 support that fixes the plate-shaped member. The plate-shaped member is made of stainless steel (SUS) processed into a plate spring shape and having a thickness of 80 μm, and a contact portion located at a free end of the plate-shaped member is in contact with the developing roller 25 with a required contact pressure. The toner supplied onto the developing roller 25 is frictionally charged by rubbing between the developing blade 35 and the developing roller 25 to be charged, and at the same time, a layer thickness thereof is regulated. In addition, in the present Example, a predetermined voltage is applied to the developing blade 35 from a blade bias power supply (not illustrated) to stabilize toner coating.

The charged toner adheres to a surface of the developing roller 25 by an image force with the developing roller 25. When an adhesion force of the toner to the surface of the developing roller 25 exceeds a regulating force of the developing blade 35, disturbance of the toner coating on the developing roller 25 (so-called “regulation failure”) occurs. When the regulation failure occurs, an image failure such as fogging in which the toner adheres to a white background of an image or density abnormality occurs.

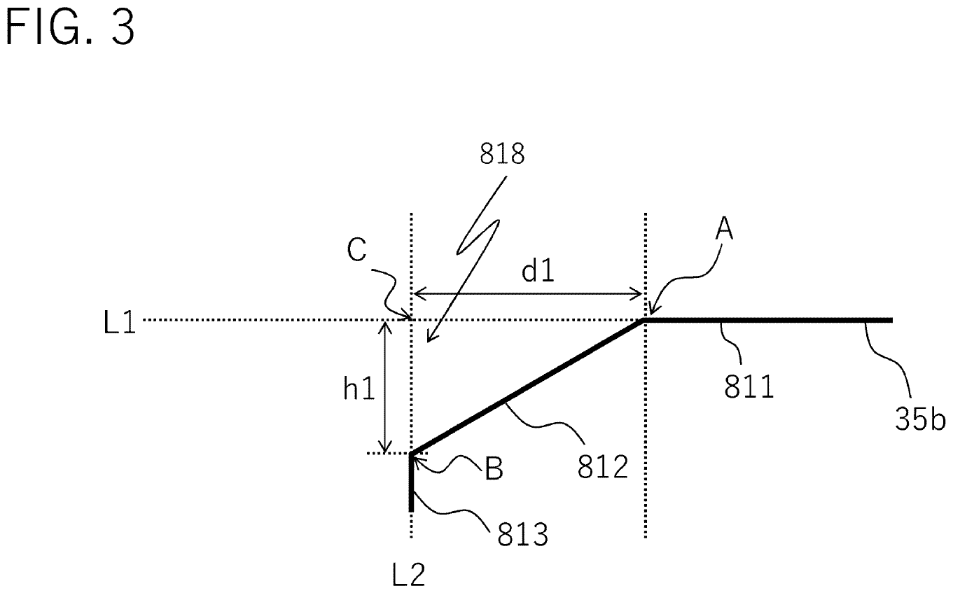

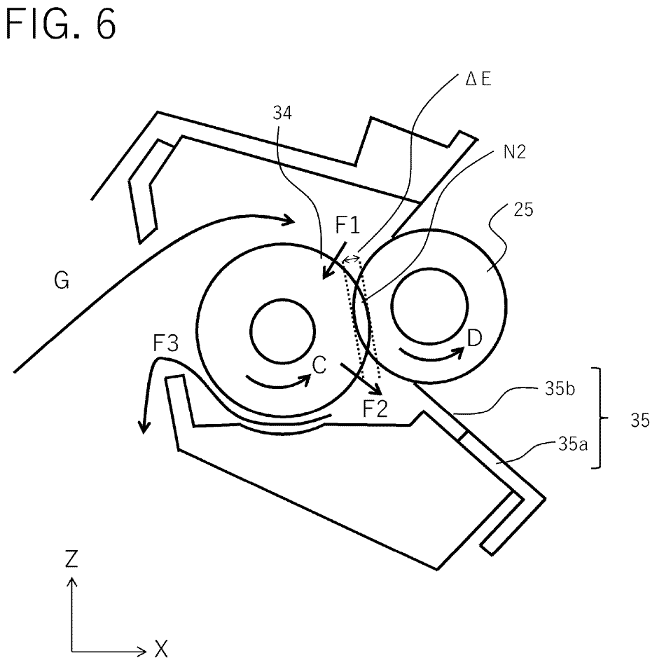

Here, the developing blade 35 of the present Example will be described in detail. In the present Example, as illustrated in FIG. 6, the developing blade 35 includes a support sheet metal 35a (blade support portion) obtained by processing stainless steel and a flexible plate-shaped member 35b (blade portion). The plate-shaped member is YAG laser-welded to the support sheet metal to be integrated with the support sheet metal. FIG. 3 is a conceptual cross-sectional view in a short direction of a free end distal end portion of the developing blade 35 according to the present disclosure. A surface 811 in FIG. 3 is a surface that is mainly in contact with the developing roller 25.

As illustrated in FIG. 3, in the present Example, a “distal end edge portion 818” on a side to be brought into contact with the developing roller 25 is partially scraped off on a distal end (free end) side of the plate-shaped member 35b by polishing. A scraped portion is formed in the entire longitudinal region of the plate-shaped member.

The developing blade 35 is disposed at a free end of the plate-shaped member 35b in the short direction, and includes a contact portion to come into contact with a surface of the developing roller 25.

More specifically, before polishing is performed, in a distal end of the developing blade 35 of the present Example, in a cross section orthogonal to a longitudinal direction, the first surface 811 (first portion) that is a surface on a side in contact with the developing roller 25 and a third surface 813 (third portion) orthogonal to the first surface 811 intersect with each other to form the above-described “distal end edge portion 818”. Then, by performing polishing, the distal end edge portion 818 is scraped off, and a second surface 812 (second portion) connecting the first surface 811 to the third surface 813 is formed. In a state after polishing, a distal end point on a free end side of the first surface 811 is defined as a point A, and a distal end point on a free end side of the second surface 812 is defined as a point B. In addition, an imaginary line obtained by extending the first surface 811 in a free end direction is defined as L1. In addition, a point at which an imaginary line L2 orthogonal to the imaginary line L1 and passing through the point B intersects with the imaginary line L1 is defined as a point C. At this time, a distance between the point B and the point C is defined as h1, and a distance between the point A and the point C is defined as d1. In the present Example, h1=15 μm and d1=40 μm.

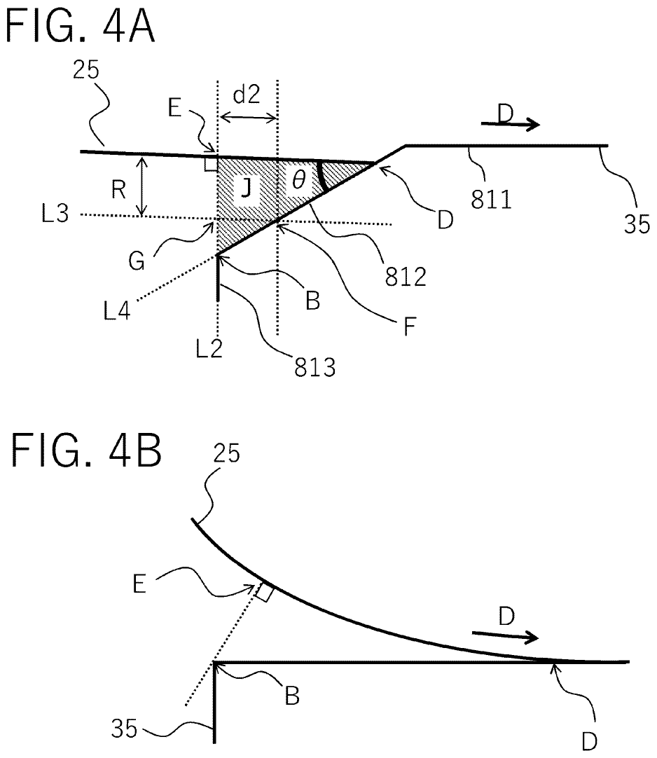

Next, a contact state between the developing roller 25 and the developing blade 35 will be described in detail with reference to FIG. 4. FIG. 4 is a schematic diagram illustrating a contact state between the developing roller 25 and the developing blade 35 in a cross section orthogonal to a longitudinal direction.

A point where a perpendicular line extending from the distal end point B of the second surface 812 in FIG. 4A to a surface of the developing roller 25 intersects with the surface of the developing roller is defined as a point E. When a contact region between the developing roller 25 and the developing blade 35 is defined as a nip N1, a contact point closest to a free end side of the developing blade 35 in the nip N1 is defined as a point D. The point D is present on the second surface 812. A region surrounded by a surface DE of the developing roller 25, a surface BD of the developing blade, and the imaginary line L2 (shaded region in FIG. 4A) can be defined as “take-in region J”.

In the present Example, in a state where the developing roller 25 is assembled, setting is performed such that a surface of the developing roller 25 and the distal end position B of the second surface do not come into contact with each other, that is, at least a part of the second surface does not come into contact with the developing roller 25. As a result, a state is created in which the entire region of the “take-in region J” is not covered by the developing roller 25, and an appropriate amount of toner coating can be formed on the developing roller 25 after passing through the developing blade 35. In other words, it can be said that by ensuring the “take-in region J”, the toner coating amount is increased, and the toner is regulated in a weak direction.

Here, when an imaginary line whose distance from the surface of the developing roller 25 is a volume average particle size R of the toner is defined as L3, an intersection point between L3 and the second surface 812 is defined as F, a point between the imaginary line L3 and the imaginary line L2 is defined as G, and a tangent line at the point F as a tangent line to the second surface 812 is defined as an imaginary line L4, a distance between the point F and the point G is defined as d2, and an angle formed by the imaginary line L4 and a straight line DE is defined as θ. In the present Example, the volume average particle size R of the toner is 7.0 μm, d2=20 μm, and θ2=20°. The volume average particle size (volume-based median diameter) of the toner was measured using a “Coulter Counter Multisizer 3” (registered trademark, manufactured by Beckman Coulter, Inc.).

Here, a method for polishing the developing blade 35 used in the present disclosure will be described. A plate-shaped member before being joined to a support member is fixed to a pedestal by being sandwiched between the pedestal and a pressing member. A polishing film wound around a rubber roller is in contact with a distal end portion of the plate-shaped member in a state where a load is applied. In the present Example, a wrapping film sheet having a particle size of #800 was used as the polishing film, and a load of 500 g was applied to the rubber roller.

The polishing film on the rubber roller is disposed in a fixed state, and by movement of the pedestal from side to side in a longitudinal direction, a distal end portion of the plate-shaped member is rubbed with the polishing film, and finely scraped off.

A scraped amount of the plate-shaped member is proportional to a distance rubbed with the polishing film, and the scraped amount increases as the rubbed distance increases, and the scraped amount decreases as the distance decreases. That is, by controlling a movement amount of the pedestal, the scraped amount of a distal end edge portion of the plate-shaped member can be changed. The above polishing method is an example, and is not limited thereto as long as the distal end shape of the developing blade can be processed into a desired shape.

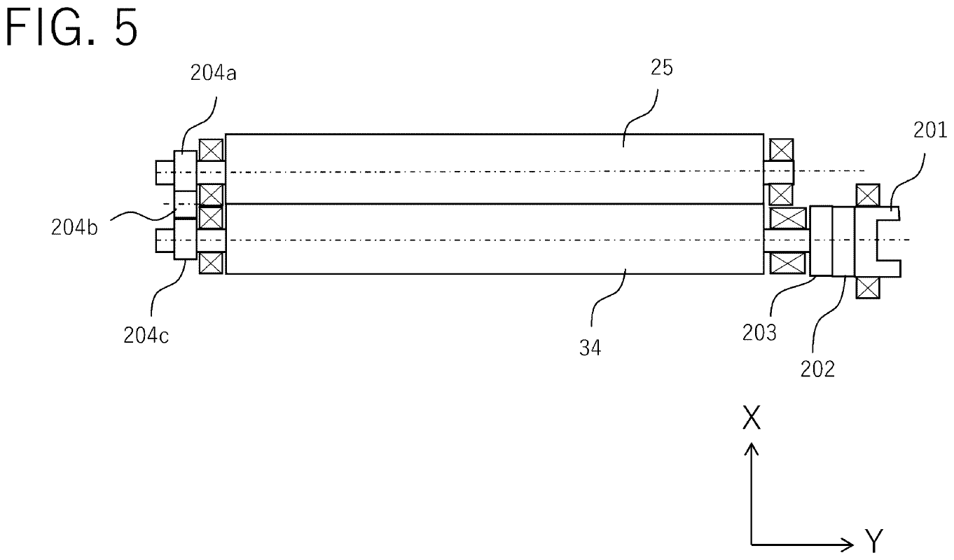

The toner supply roller 34 is in contact with the developing roller 25 with a nip portion N2 held therebetween, and as illustrated in the drawing, the toner supply roller 34 receives a driving force of a driving motor (not illustrated) to be rotationally driven according to an image forming operation. This will be described in detail with reference to FIG. 5.

A driving force from a main body driving motor is transmitted to a coupling 201 (driving force receiving portion), and the driving force is transmitted to the toner supply roller 34 via an intermediate body 202 and a drive transmission member 203 (the intermediate body 202 and the drive transmission member 203 constitute a first driving force transmitting portion). The driving force of the toner supply roller 34 is transmitted to the developing roller 25 by gears (204a to 204c) disposed between the toner supply roller 34 and the developing roller 25, and the developing roller 25 rotates (the gear 204c is a second driving force transmitting portion, and the gear 204a is a third driving force transmitting portion). Specifically, by rotation of the gear 204c fixed to the toner supply roller 34, the driving force is transmitted to an idler gear 204b, and the idler gear 204b rotates. By rotation of the idler gear 204b, the driving force is transmitted to the gear 204a fixed to the developing roller 25, and the developing roller 25 rotates together with the gear 204a.

In the present Example, a driving force from the apparatus main body 100a to the developing unit 4 is input from a longitudinal axis of the toner supply roller 34. However, in a case of adopting a configuration in which the driving force from the apparatus main body 100a to the developing unit 4 is input from a longitudinal axis of the developing roller 25, drive input positions to the cleaning unit 26 and the developing unit 4 are close to each other because development is performed while the photosensitive drum 1 and the developing roller 25 are in contact with each other. With such an arrangement of the input unit, it is difficult to simply configure a drive input unit of the apparatus main body 100a, which is not preferable when a more stable drive input unit is configured at low cost.

On the other hand, in the present Example, since the driving force to the developing unit 4 is input from the longitudinal axis of the toner supply roller 34, the distance between the input position to the cleaning unit 26 and the drive input position to the developing unit 4 can be increased, which is more preferable when the drive input unit of the apparatus main body 100a is configured.

On the other hand, in a configuration in which a driving force from the apparatus main body 100a of the present Example is transmitted to the developing roller 25 via the toner supply roller 34, the transmission needs to be performed via a plurality of gears for driving the developing roller 25. Therefore, rotation stability of the developing roller 25 is inferior to the configuration in which the driving force is transmitted to the developing roller 25. As a result, a regulating force of the developing blade 35 may be unstable, which is disadvantageous for regulation failure.

In addition, the toner supply roller 34 and the developing roller 25 rotate with a circumferential speed difference in opposite directions in the nip portion N2, and by this operation, the toner is supplied to the developing roller 25 while the residual toner on the developing roller 25 is collected.

In the present Example, when a peripheral speed of the toner supply roller 34 in the nip portion N2 is defined as Vrs and a peripheral speed of the developing roller 25 is defined as Vd, setting is performed such that Vrs/Vd>1 or Vrs/Vd=1.25 is satisfied. That is, when a radius of the toner supply roller 34 is represented by Rrs [mm], a rotational angular velocity of the toner supply roller 34 is represented by ωrs [rad/sec], a radius of the developing roller 25 is represented by Rd [mm], a rotational angular velocity of the developing roller 25 is represented by od [rad/sec], and a rotational angular velocity ratio between the toner supply roller 34 and the developing roller 25 is represented by λ (=ωrs/ωd), λ×Rrs/Rd>1.0 is satisfied. In the present Example, since a radius of the toner supply roller is 6.6 mm and a radius of the developing roller is 6.0 mm, λ≈1.14 is satisfied.

By setting Vrs/Vd>1, the residual toner on the developing roller 25 can be efficiently collected, and the toner can be efficiently supplied to the developing roller 25. On the other hand, the amount of supplied toner increases, which is disadvantageous from a viewpoint of regulation failure.

At this time, by adjusting a potential difference between the toner supply roller 34 and the developing roller 25, the collection amount of the residual toner on the developing roller 25 and the toner supply amount to the developing roller 25 can be adjusted.

In addition, the toner supply roller 34 and the developing roller 25 are in contact with each other with a predetermined entry amount, that is, a recessed amount ΔE by which the toner supply roller 34 is recessed by the developing roller 25.

The toner supply roller 34 includes a conductive support and a foamed layer supported by the conductive support. Specifically, the toner supply roller 34 includes a core electrode having an outer diameter of φ5 (mm), serving as the conductive support, and a foamed urethane layer including a continuous foamed body (continuous foam) in which air bubbles are connected to each other around the core metal electrode, serving as the foamed layer, and rotates in a direction of C in the drawing. By forming the urethane on the surface layer into the continuous foamed body in this manner, a large amount of toner can enter the toner supply roller 34. Resistance of the toner supply roller 34 in the present Example is 1×10\hat{ }9 (Ω).

Note that, in the present Example, the entry amount of the toner supply roller 34 to the developing roller 25, that is, the recessed amount ΔE by which the toner supply roller 34 is recessed by the developing roller 25 is set to 1.0 mm. Here, a method for measuring the resistance of the toner supply roller 34 will be described. The toner supply roller 34 is brought into contact with an aluminum sleeve having a diameter of 30 mm such that an entry amount described later is 1.5 mm. By rotating the aluminum sleeve, the toner supply roller 34 is rotated following the aluminum sleeve at 30 rpm.

Next, a DC voltage of −50 V is applied to the developing roller 25. At this time, a current is calculated by disposing a resistor of 10 kΩ on a ground side and measuring a voltage between both ends thereof, and resistance of the toner supply roller 34 is calculated. In the present embodiment, a surface cell diameter of the toner supply roller 34 is 50 μm to 1000 μm.

Here, the cell diameter refers to an average diameter of foamed cells in an arbitrary cross section. First, the area of the largest foamed cell is measured from an enlarged image of an arbitrary cross section, and an equivalent perfect circle diameter is converted from this area to obtain a maximum cell diameter. Then, a foamed cell having a diameter of ½ or less of the maximum cell diameter is deleted as noise, and then individual cell diameters are similarly converted from the remaining individual cell areas. The cell diameter refers to an average value of the individual cell diameters.

The toner supplied from the toner supply roller 34 to a surface of the developing roller 25 is frictionally charged by rubbing between the developing blade 35 and the developing roller 25, charges are imparted to the toner, and at the same time, a layer thickness thereof is regulated. Thereafter, the toner is conveyed to a contact portion (developing portion) between the photosensitive drum 1 and the developing roller 25, and is transferred to a bright part potential portion. The residual toner remaining on the surface of the developing roller 25 returns to the inside of the developing container again, is collected from the surface of the developing roller 25 by the toner supply roller 34, and is stored in the toner supply roller 34.

Here, a flow of toner in the developing chamber 31b will be described with reference to FIG. 6. In the present Example, FIG. 6 is an enlarged schematic cross-sectional view of the inside of the developing chamber 31b, and illustrates movement of toner conveyed to the toner supply roller 34 by a toner conveying member 36 illustrated in FIG. 2.

A part of toner G conveyed to an upper portion of the toner supply roller 34 by the toner conveying member 36 is sucked into the toner supply roller 34 by restoration of the toner supply roller 34 on a rotation downstream side of the toner supply roller 34 in the nip portion N2 (F1), and is stored in the toner supply roller 34 together with the residual toner collected from the surface of the developing roller 25 and stored in the toner supply roller 34. Then, by rotation of the toner supply roller 34 in a C direction, the toner G is conveyed to a rotation downstream side of the toner supply roller 34 of the nip portion N2. On the rotation downstream side of the toner supply roller 34, the toner stored inside is discharged by deformation of the toner supply roller 34 due to the toner supply roller 34 coming into contact with the developing roller 25 (F2).

Among particles of the toner discharged from the toner supply roller 34, particles of the toner that have not reached the surface of the developing roller 25 are gradually conveyed by a propulsion force in a direction of a developing opening (opening) due to an ejection force by the discharge from the toner supply roller 34, and are returned to the toner storing chamber 31a through the developing opening (F3).

As described above, the toner favorably circulates between the developing chamber 31b and the toner storing chamber 31a, whereby deterioration of the toner is suppressed, and even when an image with a low printing rate is continuously output, occurrence of toner aggregation is suppressed, and a high-quality image can be stably output.

Here, when a flow (F3) of the toner returning to the toner storing chamber 31a is insufficient, the toner is pressed and aggregated in a region below the toner supply roller 34 and the developing roller 25. Then, the toner enters the nip portion N2 between the toner supply roller 34 and the developing roller 25, and contact of the toner supply roller 34 with the developing roller 25 is insufficient. A region where the residual toner on the developing roller 25 cannot be sufficiently collected by the toner supply roller 34 is generated, specific particles of the toner rotate along the developing roller 25 and pass through a contact portion between the developing blade 35 and the developing roller 25 more than necessary, whereby toner particles that are excessively charged are generated. As a result, the adhesion force of the toner exceeds the regulating force of the developing blade 35, and regulation failure may occur.

Such a phenomenon is likely to occur, for example, when an image with a low printing rate is continuously output in a low temperature and low humidity environment. This is because the residual toner collected from the developing roller 25 by the toner supply roller 34 accumulates in the developing chamber 31b. Since the residual toner collected from the developing roller 25 is charged, particles of the toner are likely to be electrostatically aggregated with each other. Then, fluidity of the toner in the developing chamber 31b decreases, the flow (F3) of the toner returning to the toner storing chamber 31a is insufficient, and toner aggregation easily occurs in a region below the toner supply roller 34 and the developing roller 25.

On the other hand, there is a method for creating the flow (F3) of the toner returning to the toner storing chamber 31a by disposing a toner conveying member below the toner supply roller 34 in the developing chamber 31b. However, when the toner conveying member is disposed in the developing chamber 31b, toner deterioration progresses due to friction between the toner and the toner conveying member in the developing chamber 31b, and thus, toner fusion to the developing roller 25 is observed in a case where an image with a low printing rate continues. In addition, since the toner conveying member needs to be disposed in addition to the toner supply roller 34 in the developing chamber 31b, the apparatus configuration is complicated. Therefore, in the present Example, in addition to the developing roller 25 and the toner supply roller 34, no member that receives motor drive and is driven is disposed in the developing chamber 31b.

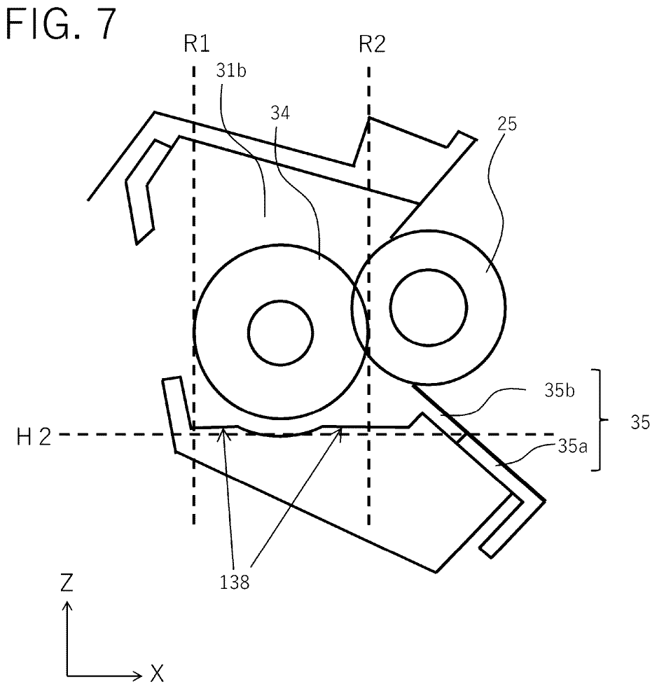

In addition, in the configuration in which no member other than the developing roller 25 and the toner supply roller 34 is disposed in the developing chamber 31b, an inner wall of the developing chamber 31b is set to the toner supply roller 34 as follows in order to efficiently use the toner in the developing chamber 31b. This will be specifically described with reference to FIG. 7.

In FIGS. 7, R1 and R2 represent tangent lines (vertical lines) of an outer peripheral surface of the toner supply roller 34 extending in the vertical direction. A horizontal line H2 indicates a horizontal line passing through a support end of the developing blade 35. In a region between R1 and R2 of the inner wall of the developing chamber 31b, at least a part is located vertically above the horizontal line H2 (region 138 in the drawing). As a result, in the toner in the developing chamber 31b, the toner remaining in the developing chamber 31b without being used for printing can be further reduced, and the toner in the developing chamber 31b can be efficiently used.

In addition, as illustrated in FIG. 2, a blowout prevention sheet 20 as a developing contact sheet for preventing the toner from being leaked from the developing frame body 31 in contact with the developing roller 25 is disposed.

Furthermore, in the toner storing chamber 31a of the developing frame body 31, the toner conveying member 36 that stirs the stored toner and conveys the toner to the toner supply roller 34 is disposed. As illustrated in FIG. 2, the toner conveying member 36 includes a stirring shaft 36a rotatable by a driving force from the apparatus main body 100a, and a sheet member 36b attached to the stirring shaft 36a and rotating together with the stirring shaft 36a.

Next, toner conveyance of the developing unit will be described. In the toner storing chamber 31a, a deformation portion 31al in contact with the sheet member 36b is disposed below an opening 31c (communication port). The sheet member 36b comes into contact with the deformation portion 31al as the sheet member 36b rotates. As a result, the sheet member 36b receives a force from the deformation portion 31al. As a result, the sheet member 36b deforms against an elastic force of the sheet member 36b. In addition, by rotating in a state of being in contact with the deformation portion 31al, the sheet member 36b conveys the toner onto a surface thereof on a rotation downstream side in a state of carrying the toner. In the present Example, the deformation portion 31al refers to a portion of the inner wall of the toner storing chamber up to a portion where the sheet member 36b is separated as illustrated in FIG. 2.

In addition, in the toner storing chamber 31a, a restoration portion 31a2 is disposed on a downstream side of the deformation portion 31al and on an upstream side of the opening 31c in the rotation of the sheet member 36b. Here, the restoration portion 31a2 is a portion that releases contact between the sheet member 36b and the inner wall of the toner storing chamber 31a. In the present Example, the restoration portion 31a2 is disposed above a horizontal plane including a rotation shaft of the stirring member.

Therefore, after a distal end of the sheet member 36b on a free end side passes through the deformation portion 31al as the sheet member 36b rotates, the contact of the sheet member 36b with the inner wall is released in the restoration portion 31a2. Then, the sheet member 36b is released from the state of being deformed by the deformation portion 31a1, and is restored to a natural state (original shape) by its own elastic restoring force. Due to the shape change of the sheet member 36b to the restoring direction, the toner carried on the sheet member 36b and conveyed flies against gravity toward the opening 31c. The opening 31c is located on a rotation direction downstream side of the sheet member 36b with respect to the restoration portion 31a2. A part of the toner flying toward the opening 31c is conveyed into the developing chamber 31b. On the other hand, the toner that has not reached the inside of the developing chamber 31b falls into the toner storing chamber 31a, stays at a bottom of the toner storing chamber 31a, and returns to the original state again. By repeating this cycle, the toner is stirred and conveyed.

The configuration in which the deformation portion 31al and the restoration portion 31a2 are disposed is advantageous for enhancing conveyance efficiency of the toner to the developing chamber 31b, but easily hinders the flow (F3) of the toner returning to the toner storing chamber, and therefore easily causes regulation failure.

In addition, in the present Example, the length of the sheet member 36b in a radial direction of a rotation axis in a natural state is set to be longer than a distance from the rotation shaft to a lower end of the developing opening in the same direction. This configuration is advantageous for enhancing conveyance efficiency of the toner to the developing chamber 31b, but easily hinders the flow (F3) of the toner returning to the toner storing chamber 31a, and therefore easily causes regulation failure.

In addition, in the present Example, in order to be able to convey a sufficient amount of toner from the toner storing chamber 31a to the developing chamber 31b, two sets of sheet members 36b are attached while attachment positions thereof on the stirring shaft 36a are shifted from each other. This configuration is advantageous for enhancing conveyance efficiency of the toner to the developing chamber 31b, but easily hinders the flow (F3) of the toner returning to the toner storing chamber 31a, and therefore easily causes regulation failure.

### [Toner]

Next, the toner in the present disclosure will be described. Hereinafter, the description “XX or more and YY or less” or “XX to YY” representing a numerical range means a numerical range including a lower limit and an upper limit which are endpoints, unless otherwise specified. When the numerical ranges are listed in stages, an upper limit and a lower limit of each numerical range can be arbitrarily combined. “(Meth)acrylic” means “acrylic” and/or “methacrylic”.

The toner in the present Example is a toner containing toner particles containing a binder resin, at least containing hydrotalcite particles used as a microcarrier in order to enhance negative polarity charging characteristics of the toner particles. In addition, the hydrotalcite particles contain fluorine. The hydrotalcite particles are particles having high chargeability to a positive polarity, and therefore have a strong positive polarity. By inclusion of fluorine in the hydrotalcite particles, a charge amount can be adjusted such that the hydrotalcite particles do not have a strong positive polarity. By inclusion of fluorine, the hydrotalcite particles can be suppressed from being charged to a strong positive polarity, and therefore the toner can be suppressed from having a strong negative polarity. That is, a toner charge distribution can be a negative polarity sharp distribution. As an example, a toner containing hydrotalcite not containing fluorine in toner particles (toner 1 described later) and a toner containing hydrotalcite containing fluorine in the same toner particles (toner 1 described later) were prepared, and charge amount distributions of the toners were measured. Using the image forming apparatus 100 and the process cartridge 70 of the present Example, toner on the developing roller 25 is collected after one plain (solid white) image is formed. The charge amount of the collected toner was measured. The charge amount was measured using E-SpartAnalyzer manufactured by Hosokawa Micron Corporation. As a toner having a strong negative polarity, a ratio of the number of toner particles having a charge amount Q/M per unit weight of −25 [μC/g] or more (evaluated as an absolute value) was compared. Then, it was confirmed that the ratio of the number of toner particles having a strong negative polarity was reduced by about 23% in the toner to which hydrotalcite containing fluorine was externally added as compared with the toner to which hydrotalcite not containing fluorine was externally added.

By using such a toner to which hydrotalcite containing fluorine is externally added and the developing blade 35 having the “take-in region J” at the distal end edge portion described above, regulation failure can be suppressed. A mechanism thereof will be described below.

In the developing blade 35 having the “take-in region J” at the distal end edge portion as illustrated in FIG. 4A, a charge of the toner is transferred by rubbing between the toner particles in the “take-in region J”. As a result, a charge distribution of the toner passing through the regulating portion of the developing blade 35 can be sharp.

On the other hand, in a case where the developing blade 35 not having the “take-in region J” as illustrated in FIG. 4B is used, it is necessary to set a contact position of the developing roller 25 with respect to the developing blade 35 on a fixed end side in order to obtain a toner coating amount for obtaining a desired image density.

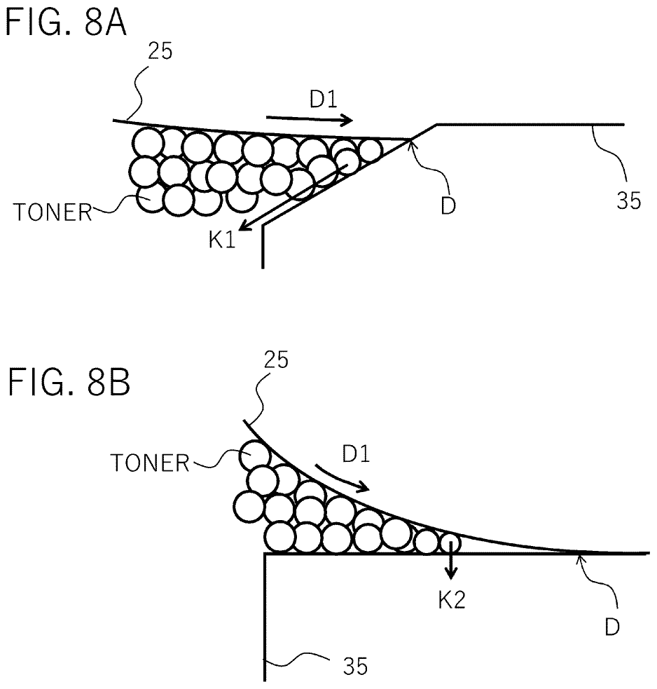

Movement of the toner regulated by the developing blade 35 in each of a case of using the developing blade 35 having the “take-in region J” at the distal end edge portion and a case of using the developing blade 35 not having the “take-in region J” at the distal end edge portion will be described with reference to FIG. 8.

FIG. 8A is a diagram illustrating a case of using the developing blade 35 having the “take-in region J” at the distal end edge portion. A white circle in the drawing represents toner, and movement of the toner regulated by the developing blade 35 is represented by an arrow K1. A part of the toner that has entered the vicinity of a contact point D with the developing blade 35 by rotation of the developing roller 25 in a direction of an arrow D1 is separated from a surface of the developing roller 25 by a regulating force of the developing blade 35. Since movement of the regulated toner in a direction in which a powder pressure of the toner from the rear is weak is enhanced, movement of returning to the inside of the developing chamber 31b along the second surface 812 of the distal end edge portion is generated. As a result, favorable circulation of the toner can be made in the “take-in region J” of the distal end edge portion, and a charge of the toner can be transferred by rubbing between the toner particles in the circulation.

In the “take-in region J” of the distal end edge portion of the developing blade 35, at least a point F on the developing blade 35 away from the developing roller 25 by the volume average particle size R of the toner is present, and a width d2 of the take-in region on a free end side of the point F is larger than the volume average particle size R of the toner, that is, one toner particle can be present in the “take-in region”, whereby it is considered that the toner circulation described above occurs. The volume average particle size of the toner used in the present Example is about 7.0 μm, and a distal end shape of the developing blade is polished such that the above point F is present and d2 is larger than the toner volume average particle size R.

In addition, preferably, when an angle θ formed by the developing blade 35 and the developing roller 25 at the point F is set to 45° or less, a direction of the arrow K1 is more opposite to a moving direction of the developing roller 25, and thus, rubbing between the toner particles in the “take-in region J” occurs more frequently, and the effect of transfer of a charge of the toner is easily exhibited. More preferably, when 0 is 25° or less, the above effect is more easily exhibited.

On the other hand, FIG. 8B is a diagram illustrating a case of using the developing blade 35 not having the “take-in region J” at the distal end edge portion. In a case where such a developing blade 35 is used, it is necessary to set the contact point D of the developing roller 25 with respect to the developing blade 35 on a fixed end side as compared with the developing blade 35 of FIG. 8A in order to obtain a toner coating amount for obtaining a desired image density. With such a setting, a sufficient amount of toner can be taken into the regulating portion. At this time, the toner regulated by a regulating force of the developing blade 35 hardly returns to the inside of the developing chamber 31b due to a powder pressure of the toner conveyed from the rear by rotation of the developing roller 25. Therefore, as a result, a force is generated in the direction K2 in which the developing blade 35 is pushed up by the regulated toner. Then, a contact pressure of the developing blade 35 with the developing roller 25 decreases, and a regulating force by the developing blade 35 is weakened. As a result, an adhesion force of the toner to the developing roller 25 exceeds the regulating force of the developing blade 35, and regulation failure may occur.

In a case where the toner to which hydrotalcite not containing fluorine is externally added is used, the number of toner particles having a strong negative polarity is increased as compared with the toner to which hydrotalcite containing fluorine is externally added as described above. Then, in a case where the developing blade 35 not having the “take-in region J” at the distal end edge portion is used, a regulating force of the developing blade 35 is weakened similarly to the toner to which hydrotalcite containing fluorine is externally added, and regulation failure is likely to occur.

In addition, even if toner particles are rubbed with each other in the “take-in region J” using the developing blade 35 having the “take-in region J” at the distal end edge portion, a ratio of the number of toner particles having a strong negative polarity increases. As a result, a toner particle having an adhesion force to the developing roller 25 exceeding the regulating force of the developing blade 35 is generated, and regulation failure may occur.

In addition, when the number of toner particles having a strong negative polarity increases, electrostatic aggregation of the toner particles is likely to occur. Then, the flow (F3) of the toner to the toner storing chamber 31a may be deteriorated and insufficient. As a result, regulation failure may occur.

Summarizing the above, by using a toner to which hydrotalcite containing fluorine is externally added and the developing blade 35 having the “take-in region J” at the distal end edge portion, the toner can be suppressed from being charged to a strong negative polarity by an effect of promoting rubbing between the toner particles by the “take-in region J”. As a result, it is possible to suppress generation of a toner particle having an adhesion force to the developing roller 25 exceeding the regulating force of the developing blade 35. At the same time, it is also possible to suppress electrostatic aggregation of the toner particles, and it is possible to suppress occurrence of toner aggregation in a region below the toner supply roller 34 and the developing roller 25 by sufficiently maintaining the flow (F3) of the toner to the toner storing chamber 31a.

Due to these two effects, by using such a toner to which hydrotalcite containing fluorine is externally added and the developing blade 35 having the “take-in region J” at the distal end edge portion described above, occurrence of regulation failure can be suppressed.

In the present Example, in order to more actively transfer a charge of the toner by rubbing between toner particles in the “take-in region J”, the take-in angle θ is set to satisfy 0°<θ<25°. As a result, a charge distribution of the toner passing through the regulating portion of the developing blade 35 can be sharp.

The hydrotalcite particles used for the toner in the present Example will be described in detail. The hydrotalcite particles contain fluorine. Here, presence or absence of fluorine in the hydrotalcite particles can be confirmed by STEM-EDS mapping analysis of the toner. For analysis conditions and the like, a method described later is adopted. In the hydrotalcite particles, fluorine is present inside the hydrotalcite particles in line analysis in STEM-EDS mapping analysis of the toner. Specifically, it means that EDS line analysis is performed in a normal direction on an outer periphery of the hydrotalcite particles containing fluorine, and fluorine present inside the particles is detected. The detection of fluorine inside the hydrotalcite particles by the above-described analysis indicates that fluorine is intercalated between layers of the hydrotalcite particles. By presence of fluorine inside the hydrotalcite particles, the hydrotalcite particles are not excessively charged to a positive polarity, and an appropriate charge amount of a positive polarity can be maintained. The hydrotalcite particles can maintain an appropriate charge amount of a positive polarity because by presence of fluorine having a strong negative polarity inside the hydrotalcite particles, positive polarity charges on a surface of the hydrotalcite particles can be taken into the particles and neutralized. That is, it is presumed that this is because excessive charging of the particle surface to a positive polarity can be suppressed.

Note that, in introduction of fluorine into the hydrotalcite particles, fluoride ions are preferably introduced (intercalated) between layers by anion exchange.

A value F/Al (elemental ratio) of a ratio of an atomic number concentration of fluorine to aluminum in hydrotalcite particles, obtained from principal component mapping of the hydrotalcite particles by STEM-EDS mapping analysis of the toner is preferably 0.01 to 0.65. Furthermore, F/Al is more preferably 0.02 to 0.60.

Specifically, when F/Al is 0.01 or more, a surface charge distribution of the hydrotalcite particles can be uniform, and charge stability of the toner is favorable. As a result, a toner sharply charged in a negative polarity can be obtained.

When F/Al is 0.65 or less, a surface charge of the hydrotalcite particles is suppressed from being excessively neutralized, time stability of a positive charge is enhanced, and charge stability of the toner is favorable. As a result, it is possible to suppress the charge of the toner from having a strong negative polarity, and to obtain a toner having a sharp negative polarity charge distribution.

The atomic number concentration of fluorine in the hydrotalcite particles is not particularly limited, but is preferably 0.01 atomic % to 5.00 atomic %, more preferably 0.04 atomic % to 3.00 atomic %, and still more preferably 0.09 atomic % to 2.00 atomic %. Within this range, a positivity of the hydrotalcite particles is moderate, and microcarrier characteristics are in an appropriate range.

As the hydrotalcite particles, hydrotalcite particles represented by the following composition formula (1) can be used. Note that, in the composition formula (1), M and A are represented as ions.

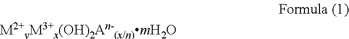

M²⁺ and M³⁺ represent a divalent cation of a metal and a trivalent cation of a metal, respectively.

The hydrotalcite particles may be a solid solution containing a plurality of different elements. In addition, the hydrotalcite particles may contain a small amount of monovalent metal.

Note that 0<x≤0.5, y=1−x, and m≥0 are preferably satisfied.

M²⁺ is preferably a divalent cation of at least one metal selected from the group consisting of Mg, Zn, Ca, Ba, Ni, Sr, Cu, and Fe.

M³⁺ is preferably a trivalent cation of at least one metal selected from the group consisting of Al, B, Ga, Fe, Co, and In.

Aⁿ⁻ is an n-valent anion and contains at least F⁻. Aⁿ⁻ may contain, in addition to F⁻, CO₃²⁻, OH⁻, Cl⁻, I⁻, Br⁻, SO₄²⁻, HCO₃⁻, CH₃COO⁻, NO₃⁻, and the like, and may contain a plurality of different anions.

The metal to be the above divalent cation is preferably Mg (magnesium), and the metal to be the above trivalent cation is preferably Al (aluminum). The hydrotalcite particles preferably contain aluminum to be a trivalent cation and magnesium to be a divalent cation. Specific examples of the composition formula include Mg²⁺_{8.6}Al³⁺₄(OH)_{25.2}F⁻₂CO₃²⁻·mH₂O and Mg²⁺₁₂Al³⁺₄(OH)₃₂F⁻₂CO₃²⁻·mH₂O.

When the hydrotalcite particles contain aluminum to be a trivalent cation and magnesium to be a divalent cation, a value of a ratio (Mg/Al) of an atomic number concentration (atomic %) of magnesium to an atomic number concentration (atomic %) of aluminum is preferably 1.50 to 4.00.

In addition, the hydrotalcite particles preferably have water in a molecule thereof, and more preferably satisfy 0.1<m<0.6 in the formula (1).

A number average particle size H3 of primary particles of the hydrotalcite particles is preferably 40 nm to 1100 nm, and more preferably 60 nm to 1000 nm. When the number average particle size of the hydrotalcite particles is in the above range, a charge rising property of the toner is favorable, and a charge distribution of the toner is easily sharpened.

The above particle size can be measured using a known means such as a scanning electron microscope. The above particle size can be controlled by controlling conditions of a reaction step, a pulverization step, a centrifugation step, a classification step, and a sieving step in a hydrotalcite particle manufacturing process.

The hydrotalcite particles may be hydrophobized with a surface treatment agent. As the surface treatment agent, higher fatty acids, coupling agents, esters, and oils such as a silicone oil can be used. Among these, higher fatty acids are preferably used, and specific examples thereof include stearic acid, oleic acid, and lauric acid.

The content of the hydrotalcite particles in the toner is not particularly limited. The content of the hydrotalcite particles is preferably 0.01 parts by mass to 3.00 parts by mass, more preferably 0.05 parts by mass to 0.50 parts by mass, and still more preferably 0.05 parts by mass to 0.30 parts by mass with respect to 100 parts by mass of the toner particles. The content of the hydrotalcite particles can be quantified using a calibration curve prepared from a standard sample using X-ray fluorescence analysis.

A fixation ratio of the hydrotalcite particles to the toner particles is preferably 10% to 95%. The fixation ratio is more preferably 40% to 95%, and still more preferably 50% to 70%. Within the above range, the above effect is easily obtained. The fixation ratio can be controlled by changing external addition conditions in a known external addition method.

An area ratio of the hydrotalcite particles to the toner particles in an EDS measurement visual field as measured by STEM-EDS mapping analysis of the toner is preferably 0.07% to 0.54%. Furthermore, the area ratio is more preferably 0.25% to 0.50%, and still more preferably 0.35% to 0.45%. Within the above range, the above effect is easily obtained. The above area ratio can be controlled by changing an input amount of the hydrotalcite particles.

### <Method for Manufacturing Toner Particles>

As a method for manufacturing the toner particles, a known means can be used without being particularly limited, and a kneading and pulverizing method or a wet manufacturing method can be used. The wet manufacturing method is preferable from a viewpoint of making particle sizes uniform, shape controllability, and easiness of obtaining toner particles having a core-shell structure. Examples of the wet manufacturing method include a suspension polymerization method, a dissolution suspension method, an emulsion polymerization aggregation method, and a difference between an emulsion aggregation method emulsion polymerization aggregation and emulsion aggregation. The emulsion aggregation method is more preferable from a viewpoint that a polyvalent metal element is dispersed on a surface of the toner particle and inside the toner particle.

In the emulsion aggregation method, first, a dispersion of materials such as fine particles of a binder resin and a colorant is prepared. The obtained dispersion of the materials is dispersed and mixed by adding a dispersion stabilizer thereto as necessary. Thereafter, the toner particles are aggregated until a desired toner particle size is obtained by adding an aggregating agent thereto, and then or simultaneously with aggregation, fusion between resin fine particles is performed. Furthermore, if necessary, shape control by heat is performed to form toner particles.

Here, the fine particles of the binder resin can be composite particles formed of a plurality of layers including two or more layers of resins having different compositions. For example, the fine particles of the binder resin can be manufactured by an emulsion polymerization method, a mini-emulsion polymerization method, a phase inversion emulsification method, or the like, or can be manufactured by combining several manufacturing methods. When an internal additive is contained in the toner particles, the resin fine particles may contain the internal additive, or a dispersion of internal additive fine particles containing only the internal additive may be separately prepared, and the internal additive fine particles may be aggregated together with the resin fine particles at the time of aggregation. In addition, it is also possible to form toner particles having a layer configuration having different compositions by adding resin fine particles having different compositions at the time of aggregation with a time difference and aggregating the resin fine particles.

As the dispersion stabilizer, a known surfactant can be used. As the aggregating agent, in addition to a surfactant having a polarity opposite to that of a surfactant used for the dispersion stabilizer described above, an inorganic salt and a divalent or higher valent inorganic metal salt can be suitably used. In particular, an inorganic metal salt is preferable because cohesiveness control and toner chargeability control are easily performed by being ionized in an aqueous medium. Specific examples of a preferable inorganic metal salt include: metal salts of calcium chloride, calcium nitrate, barium chloride, magnesium chloride, zinc chloride, iron chloride, aluminum chloride, and aluminum sulfate; and inorganic metal salt polymers of polyiron chloride, polyaluminum chloride, polyaluminum hydroxide, and calcium polysulfide. Among these, an aluminum salt and a polymer thereof are particularly suitable. In general, in order to obtain a sharper particle size distribution, the valence of the inorganic metal salt is more preferably divalent rather than monovalent, and more preferably trivalent or higher rather than divalent, and an inorganic metal salt polymer is more suitable even if the valence is the same.

A volume-based median diameter of the toner particles is preferably 3.0 μm to 10.0 μm from a viewpoint of high definition and high resolution of an image.

### <Method for Manufacturing Toner>

The toner contains hydrotalcite particles as an external additive. Another external additive may be added as necessary. In this case, the content of the external additive such as inorganic and organic fine particles containing hydrotalcite particles is preferably 0.50 parts by mass to 5.00 parts by mass in total with respect to 100 parts by mass of the toner particles.

A mixer that externally adds the external additive to the toner particles is not particularly limited, and a known mixer that is a dry type or a wet type can be used. Examples thereof include an FM mixer (manufactured by NIPPON COKE & ENGINEERING CO., LTD.), a Mitsui Henschel mixer (manufactured by Mitsui Miike Chemical Engineering Machinery, Co., Ltd.), a super mixer (manufactured by Kawata Mfg. Co., Ltd.), NOBILTA (manufactured by Hosokawa Micron Corporation), and a hybridizer (manufactured by Nara Machinery Co., Ltd.). The toner can be prepared by adjusting a rotation speed of the above external addition apparatus, a treatment time, and a water temperature and a water amount of a jacket in order to control a coating state of the external additive.

Hereinafter, a method for measuring physical properties of the toner and materials will be described.

### <Method for Identifying Hydrotalcite Particles>

The hydrotalcite particles can be identified by combining shape observation with a scanning electron microscope (SEM) and elemental analysis with energy dispersive X-ray analysis (EDS).

Using a scanning electron microscope “S-4800” (trade name: Hitachi, Ltd.), the toner is observed in a visual field enlarged up to 50,000 times. A toner particle surface is focused, and the external additive to be discriminated is observed. EDS analysis of the external additive to be discriminated is performed, and the hydrotalcite particles can be identified from the types of element peaks.

When an element peak of at least one metal selected from the group consisting of Mg, Zn, Ca, Ba, Ni, Sr, Cu, and Fe, which is a metal capable of constituting the hydrotalcite particles, and an element peak of at least one metal selected from the group consisting of Al, B, Ga, Fe, Co, and In are observed as element peaks, presence of hydrotalcite particles containing the two types of metals can be analogized.

A specimen of hydrotalcite particles analogized by EDS analysis is separately prepared, and shape observation by SEM and EDS analysis are performed. Whether or not an analysis result of the specimen matches an analysis result of the particles to be discriminated is compared to determine whether or not the particles are hydrotalcite particles.

### <Method for Measuring Each Elemental Ratio in Hydrotalcite Particles>

Each elemental ratio in the hydrotalcite particles is measured by EDS mapping measurement of the toner using a scanning transmission electron microscope (STEM). In the EDS mapping measurement, each pixel of an analysis area has spectrum data. By using a silicon drift detector having a large detection element area, EDS mapping can be measured with high sensitivity.

By performing statistical analysis on the spectral data of each pixel obtained by the EDS mapping measurement, principal component mapping in which pixels having similar spectra are extracted can be obtained, and mapping in which components are specified can be performed.

Preparation of an observation sample is performed by the following procedure.

0.5 g of the toner is weighed, and left to stand for two minutes at a load of 40 kN using a Newton press with a cylindrical mold having a diameter of 8 mm to prepare a cylindrical toner pellet having a diameter of 8 mm and a thickness of about 1 mm. A slice having a thickness of 200 nm is prepared from the toner pellet with an ultramicrotome (Leica, FC7).

STEM-EDS analysis is performed using the following apparatus under the following conditions.
Scanning transmission electron microscope; JEM-2800 manufactured by JEOL Ltd.
EDS detector; JED-2300T dry SD100GV detector (detection element area: 100 mm²) manufactured by JEOL Ltd.
EDS analyzer; NORAN System 7 manufactured by Thermo Fisher Scientific

### [Conditions of STEM-EDS]

Acceleration voltage of STEM: 200 kV
Magnification: 20,000 times
Probe size: 1 nm
STEM image size: 1024×1024 pixels (EDS element mapping images at the same position are acquired.)
EDS mapping size: 256×256 pixels, Dwell Time: 30 μs, number of integrations: 100 frames

Each elemental ratio in the hydrotalcite particles based on multivariate analysis is calculated as follows.

EDS mapping is obtained by the above STEM-EDS analyzer. Next, the collected spectral mapping data is subjected to multivariate analysis using a COMPASS (PCA) mode in a measurement command of the NORAN System 7 described above to extract a principal component map image.

At this time, setting values were as follows.
Kernel size: 3×3
Quantitative map setting: high (slow)
Filter fit type: high accuracy (slow)

At the same time, by this operation, an area ratio of each extracted principal component in the EDS measurement visual field is calculated. An EDS spectrum of the obtained each principal component mapping is subjected to quantitative analysis by a Cliff-Lorimer method.

The toner particle portion and the hydrotalcite particle are distinguished from each other on the basis of the above quantitative analysis result of the obtained STEM-EDS principal component mapping. The particle can be identified as a hydrotalcite particle from a particle size, a shape, the content of a polyvalent metal such as aluminum or magnesium, and an amount ratio thereof.

### <Method for Analyzing Fluorine and Aluminum in Hydrotalcite Particles>

Fluorine and aluminum of the hydrotalcite particles are analyzed on the basis of mapping data obtained by the above-described method and obtained by STEM-EDS mapping analysis. Specifically, EDS line analysis is performed on an outer periphery of the hydrotalcite particle in a normal direction to analyze fluorine and aluminum present inside the particle.

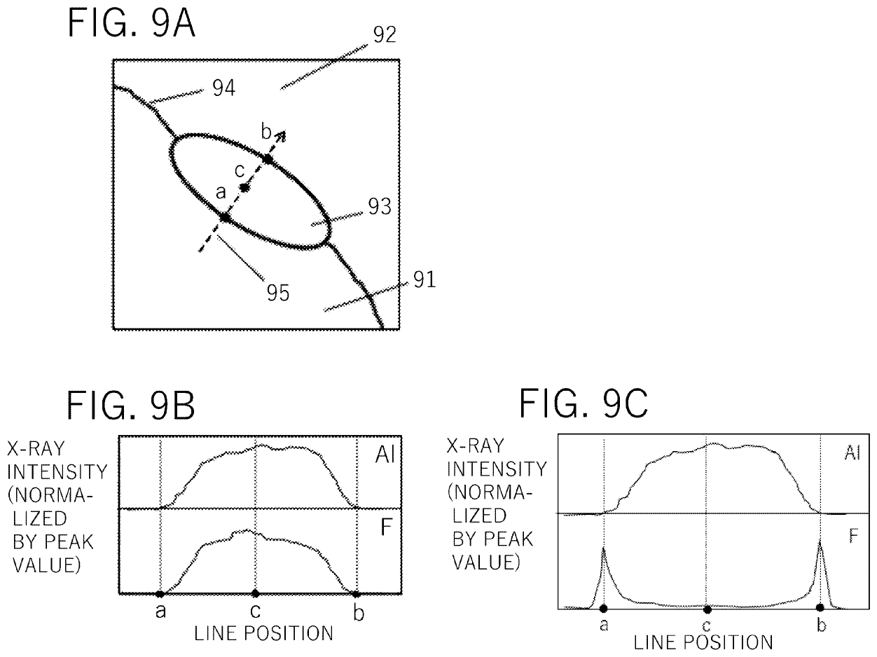

A schematic diagram of the line analysis is illustrated in FIG. 9A. In a hydrotalcite particle 93 adjacent to a toner particle 91 and a toner particle 92, line analysis is performed in a normal direction of an outer periphery of the hydrotalcite particle 93, that is, a direction of a reference numeral 95. Note that a reference numeral 94 represents a boundary between toner particles.

A range in which hydrotalcite particles are present in the acquired STEM image is selected with a rectangular selection tool, and line analysis is performed under the following conditions.
Line analysis conditions
STEM magnification: 800,000 times
Line length: 200 nm
Line width: 30 nm
Number of lines divided: 100 points (intensity measurement is performed every 2 nm)

Criteria for determining that the element is contained in the hydrotalcite particles are as follows. A case where an element peak intensity of fluorine or aluminum is 1.5 times or more a background intensity in the EDS spectrum of the hydrotalcite particles. A case where element peak intensities of fluorine or aluminum at both end portions (point a and point b in FIG. 9A) of the hydrotalcite particle in the line analysis do not exceed 3.0 times a peak intensity at a point c. When both the above conditions are satisfied, it is determined that the element is contained in the hydrotalcite particles. Note that the point c is a midpoint of a line segment ab (that is, a midpoint of the above both end portions).

Examples of X-ray intensities of fluorine and aluminum obtained by the line analysis are illustrated in FIGS. 9B and 9C. When the hydrotalcite particles contain fluorine and aluminum therein, a graph of an X-ray intensity normalized by a peak intensity indicates a shape as illustrated in FIG. 9B. When the hydrotalcite particles contain fluorine derived from a surface treatment agent, the graph of the X-ray intensity normalized by the peak intensity has peaks near points a and b at both end portions in the graph of fluorine as illustrated in FIG. 9C. By confirming the X-ray intensity derived from fluorine and aluminum in the line analysis, it can be confirmed that the hydrotalcite particles contain fluorine and aluminum therein.

### <Method for Calculating Value of Ratio (Elemental Ratio) F/Al of Atomic Number Concentration of Fluorine to Aluminum in Hydrotalcite Particles>

A value of a ratio (elemental ratio) F/Al of an atomic number concentration between fluorine and aluminum in the hydrotalcite particles, obtained from principal component mapping derived from the hydrotalcite particles by the above-described STEM-EDS mapping analysis is acquired in a plurality of visual fields. Then, an arithmetic mean of 100 or more corresponding particles is taken as the value of a ratio (elemental ratio) F/Al of an atomic number concentration of fluorine to aluminum in the hydrotalcite particles.

### <Method for Calculating Value of Ratio (Elemental Ratio) Mg/Al of Atomic Number Concentration of Magnesium to Aluminum in Hydrotalcite Particles>

Calculation is performed for magnesium and aluminum in a similar manner to the method for calculating the ratio (elemental ratio) F/Al of an atomic number concentration of fluorine to aluminum in the hydrotalcite particles described above. Then, the ratio (elemental ratio) Mg/Al of an atomic number concentration of magnesium to aluminum in the hydrotalcite particles is calculated.

### <Method for Calculating Atomic Number Concentration of Fluorine in Hydrotalcite Particles>

An atomic number concentration of fluorine in the hydrotalcite particles is calculated on the basis of mapping data obtained by the above-described method and obtained by STEM-EDS mapping analysis. In the principal component map image of the hydrotalcite particles extracted by the above-described method, the atomic number concentration (element amount) of fluorine in the hydrotalcite particles is quantified.

The mapping data is acquired in a plurality of visual fields, and an arithmetic mean of 100 or more hydrotalcite particles is defined as the atomic number concentration of fluorine in the hydrotalcite particles.

### <Method for Measuring Number Average Particle Size of Primary Particles of Hydrotalcite Particles>

A number average particle size S3 of the primary particles of the hydrotalcite particles is measured by combining a scanning electron microscope “S-4800” (trade name: manufactured by Hitachi, Ltd.) and elemental analysis with energy dispersive X-ray analysis (EDS). The toner to which hydrotalcite particles as an external additive are externally added is observed, and the hydrotalcite particles are photographed in a visual field enlarged up to 200,000 times. The hydrotalcite particles are selected from the photographed image, and 100 major axes of primary particles of the hydrotalcite particles are randomly measured to determine a number average particle size of the hydrotalcite particles. An observation magnification is appropriately adjusted according to the size of the external additive.

### <Method for Measuring Fixation Ratio of Hydrotalcite Particles to Toner Particles>

First, two types of samples (toner before water washing and toner after water washing) are prepared.
(i) Toner before water washing: Various types of toners prepared in Example described later are used as they are.
(ii) Toner after water washing: 160 g of sucrose (manufactured by Kishida Chemical Co., Ltd.) is added to 100 mL of deionized water and dissolved therein while being heated in a water bath to prepare a concentrated sucrose solution. To a centrifuge tube, 31 g of the above concentrated sucrose solution and 6 mL of Contaminon N (a 10 mass % aqueous solution of a neutral detergent for cleaning a precise measuring apparatus at pH 7, containing a nonionic surfactant, an anionic surfactant, and an organic builder, manufactured by Wako Pure Chemical Industries, Ltd.) are added to prepare a dispersion. To the dispersion, 1 g of toner is added, and lumps of the toner are broken using a spatula or the like. The centrifuge tube is shaken with a shaker at 5.8 s−1 for 20 minutes.

After shaking, the solution is transferred to a glass tube for a swing rotor (50 mL), and centrifuged at 58.3 s−1 for 30 minutes using a centrifuge. It is visually confirmed that the toner and the aqueous solution are sufficiently separated, and the toner separated to the uppermost layer is collected using a spatula or the like. The aqueous solution containing the collected toner is filtered using a vacuum filtration device and then dried in a dryer for one hour or more to prepare a sample.

For these samples before and after water washing, SEM/EDS observation is performed for a visual field aligned with centers of 20 toners randomly selected under the following conditions, and a sum of the areas of the hydrotalcite particles is calculated. A fixation ratio of the hydrotalcite particles is calculated by the following formula.

$$Fixation ratio ( \% ) of hydrotalcite particles = ( sum of areas of hydrotalcite particles of toner after water washing ) / ( sum of areas of hydrotalcite particles of toner before water washing ) \times 100$$

An apparatus and observation conditions for SEM/EDS are as follows.
Apparatus used (SEM): ULTRA PLUS manufactured by Carl Zeiss Microscopy, Co., Ltd.
Apparatus used (EDS): NORAN System 7, Ultra Dry EDS Detecter manufactured by Thermo Fisher Scientific K.K.
Acceleration voltage: 5.0 kV
WD: 7.0 mm
Aperture Size: 30.0 μm
Detection signal: SE2 (secondary electron)
Observation magnification: 50,000 times
Mode: Spectral Imaging
Pretreatment: Toner as a sample is scattered on a carbon tape and subjected to platinum sputtering.

Hereinafter, the present disclosure will be described in more detail with reference to Example and Comparative Example, but the present disclosure is not limited thereto at all. “Part” used in Example is on a mass basis unless otherwise specified.

Hereinafter, Manufacturing Examples of toner will be described.

### <Manufacturing Example of Toner Particles>

### <Preparation of Aqueous Dispersion Medium>

Water 390.0 parts
Sodium phosphate 4.2 parts

The above aqueous solution was prepared, and held at 60° C. while being stirred at a high speed to adjust a sodium phosphate aqueous solution. Next,
Water: 17.1 parts
Calcium chloride: 2.4 parts

The above aqueous solution was prepared, and then added to the above-described sodium phosphate aqueous solution. The mixture was stirred at a high speed to prepare an aqueous dispersion medium containing calcium phosphate fine particles.

### <Preparation of Polymerizable Monomer Composition 1>

Styrene: 30.0 parts
C.I. Pigment Blue 15:3: 6.0 parts
Charge control agent (aluminum complex): 0.5 parts

The above materials were dispersed at normal temperature for five hours with an attritor to obtain a polymerizable monomer composition 1.

### <Preparation of Polymerizable Monomer Composition 2>

Polymerizable monomer composition 1:46.8 parts
Styrene: 39.0 parts
n-Butyl acrylate: 25.0 parts
Polar resin 1:10.0 parts
(Styrene-methacrylic acid-methyl methacrylate-2-hydroxyethyl methacrylate copolymer, Mw=15200)
Polar resin 2:4.0 parts
(Polyester resin which is a polycondensate of propylene oxide-modified bisphenol A and terephthalic acid, Mw=9500)
Polar resin 3:1.0 part
(Styrene-2-ethylhexyl acrylate copolymer containing 10 mass % of 2-acrylamide-2-methylpropane sulfonic acid, Mp=18000)
Behenyl behenate: 6.0 parts
Hydrocarbon wax (melting point: 78° C.): 3.0 parts

The above materials were put into a temperature-adjustable stirring tank, and a temperature thereof was raised to 60° C. Thereafter, the materials were stirred for one hour to obtain a polymerizable monomer composition 2.

### <Granulation and Polymerization Step>

The polymerizable monomer composition 2 was put into an aqueous dispersion medium, and 7.0 parts of a polymerization initiator were further put thereinto. Granulation was performed at a temperature of 60° C. for ten minutes while high-speed stirring was maintained. Thereafter, the stirrer was changed to a propeller-type stirrer, the temperature was raised to 70° C., and reaction was caused for five hours. Furthermore, the temperature was raised to 80° C., reaction was caused for five hours, and then the temperature was lowered to obtain a polymer fine particle dispersion.

### <Washing, Drying, and Classifying Step>

To the above polymer fine particle dispersion, 10% hydrochloric acid was added to dissolve the calcium phosphate fine particle dispersant therein, and the mixture was filtered, washed, dried, and classified using an air classifier to obtain toner particles having a weight average particle size of 5.8 μm.

### <Preparation of Hydrotalcite Particles 1>

Sodium fluoride: 3.5 parts
Water: 350.0 parts

The above aqueous solution was prepared, and 3.5 parts of hydrotalcite (number average particle size of primary particles: 240 nm) was put thereinto. The mixture was stirred at room temperature for ten hours, filtered, dried, and crushed to obtain hydrotalcite particles 1. In line analysis in STEM-EDS mapping analysis, presence of fluorine inside the hydrotalcite particles 1 could be confirmed, and F/Al=0.11 and Mg/Al=2.45 were satisfied.

### <Hydrotalcite Particles 2>

Hydrotalcite (number average particle size of primary particles: 240 nm) used in the adjustment of the hydrotalcite particles 1 was defined as hydrotalcite particles 2. In line analysis in STEM-EDS mapping analysis, presence of fluorine inside the hydrotalcite particles 2 could not be confirmed.

### <Adjustment of Hydrotalcite Particles 3>

Methanol: 50.0 parts
Fluorine-containing silicone (X-12-2430C manufactured by Shin-Etsu Silicone Co., Ltd.): 0.3 parts
Hydrotalcite (number average particle size of primary particles: 240 nm): 5.0 parts

The above materials were put, and the mixture was stirred at room temperature for ten hours. Thereafter, 500 parts of water were put thereinto, and the mixture was stirred for one more hour, filtered, dried, and crushed to obtain hydrotalcite particles 3. In line analysis in STEM-EDS mapping analysis, presence of fluorine inside the hydrotalcite particles 3 could not be confirmed, but presence of fluorine on a surface of the hydrotalcite particles 3 could be confirmed.

### <Manufacturing Example of Toner 1>

Hydrotalcite particles 1 (0.3 parts) and hydrophobized silica (BET 380 m²/g) (1.0 part) were externally added to and mixed with the toner particles (100.0 parts) obtained above using a Mitsui Henschel mixer (Mitsui Miike Chemical Engineering Machinery, Co., Ltd.). As external addition conditions, a stirring rotation speed and a mixing time were adjusted so as to obtain a desired fixation ratio.

Thereafter, sieving was performed with a mesh having an opening of 200 μm to obtain a toner 1. A fixation ratio of the hydrotalcite particles to the toner particles was 30%.

### <Manufacturing Example of Toner 2>

A toner 2 was obtained in a similar manner to Manufacturing Example of the toner 1 except that the hydrotalcite particles used in Manufacturing Example of the toner 1 were changed to the hydrotalcite particles 2.

### <Manufacturing Example of Toner 3>

A toner 3 was obtained in a similar manner to Manufacturing Example of the toner 1 except that the hydrotalcite particles used in Manufacturing Example of the toner 1 were changed to the hydrotalcite particles 3.

### Confirmation of Effect of Present Disclosure

In each of a case of using the above toner and the developing blade 35 having the “take-in region J” at a distal end edge portion, and a case of using the above toner and the developing blade 35 not having the “take-in region J” at a distal end edge portion, horizontal lines having an image ratio of 1% were continuously printed on 5000 sheets under conditions of a temperature of 15° C. and a humidity of 10% RH, and the effect was confirmed. A toner of the present Example is the toner 1, and toners of Comparative Example are the toner 2 and the toner 3.

For verification of the effect, in order to measure a fogging density caused by regulation failure, a reflectance (%) was measured using a reflection densitometer (Model TC-MOR-45 manufactured by Tokyo Denshoku Co., Ltd., a green filter was used). In the fogging measurement, a Post-it or the like is attached to a portion of a sheet to be printed, and the sheet is output. A reflectance of a portion where the Post-it attached to the output sheet was removed was defined as a reference reflectance of the sheet itself, and fogging measurement was performed. The reflectance varies depending on a measurement portion, a difference between a measurement value at a portion having a minimum value and a measurement value at a portion to which the Post-it attached (reference reflectance) is measured as a fogging value. A smaller measured fogging value indicates a smaller fogging amount, which is preferable.

In addition, a solid black image was formed on the entire surface, and an image density was measured. A densitometer (manufactured by eXact x-rite) was used for the density measurement, and a black density was measured.

In this evaluation, in the cases of using the toner 2 and the toner 3, in both of a case of using the developing blade 35 having the “take-in region J” at a distal end edge portion and the case of using the developing blade 35 not having the “take-in region J” at a distal end edge portion, when the developing roller 25 was brought into contact with the developing blade 35 so as to obtain a desired image density, fogging due to regulation failure at a level that cannot be tolerated in actual use occurred. The desired density is 1.3 as a value of the densitometer, and the fogging amount at a level that cannot be tolerated in actual use is 5% or more. It is considered that the regulation failure occurred in the toner not containing fluorine because an excessive charge was imparted by the hydrotalcite particles.

In addition, in the case of using the toner 1 and the developing blade 35 not having the sufficient “take-in region J” at a distal end edge portion, when the developing roller 25 was brought into contact with the developing blade 35 so as to obtain a desired image density, regulation failure at a level that cannot be tolerated in actual use occurred.

On the other hand, in the case of using the toner 1 and the developing blade 35 having the “take-in region J” at a distal end edge portion, a desired image density was obtained, and occurrence of regulation failure could be suppressed.

That is, by using the toner to which hydrotalcite containing fluorine was externally added and the developing blade 35 having the “take-in region J” at a distal end edge portion, favorable image quality could be obtained.

In the present Example, the case where the developing blade 35 in which the “take-in region J” is formed by polishing a distal end edge portion is used as the developing blade 35 has been described, but the present disclosure is not limited thereto.

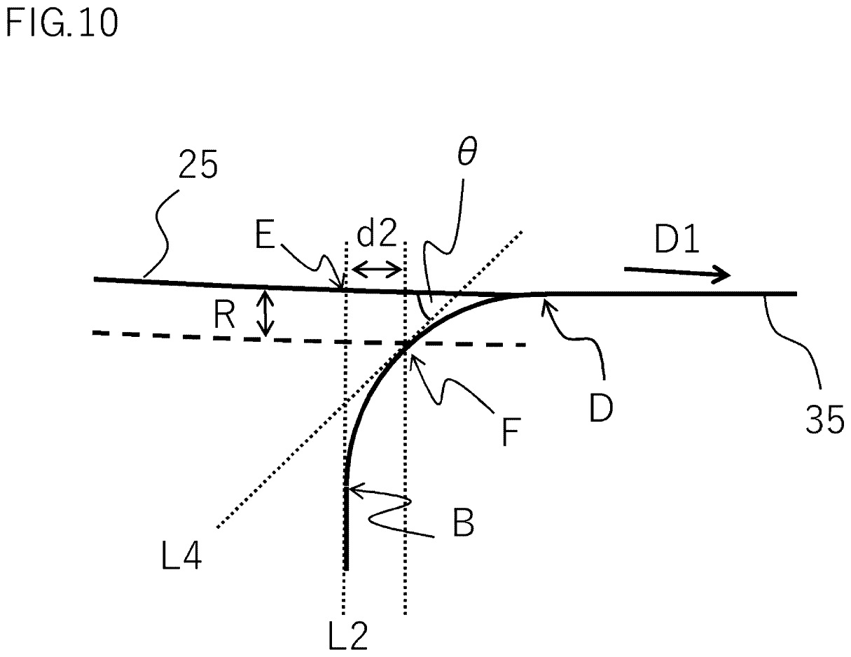

For example, as illustrated in FIG. 10, a similar effect can be obtained by using the developing blade 35 in which a distal end edge portion is bent at a predetermined curvature radius. Even in the case of using the developing blade 35 in which a distal end edge portion is bent as illustrated in FIG. 10, it is considered that a similar effect can be obtained by the fact that a point F on the developing blade 35 away from the developing roller 25 by the volume average particle size R of the toner is present in the “take-in region J” of the distal end edge portion in the developing blade 35, and a width d2 of the take-in region on a free end side of the point F is larger than the volume average particle size R of the toner.

As described above, according to the present disclosure, it is possible to provide a cartridge further developed from a conventional cartridge.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. A process cartridge attachable to an image forming apparatus, comprising:
a photosensitive drum which is an image carrier; a developing roller configured to develop a toner image on the photosensitive drum;
a supply roller configured to supply toner to the developing roller;
a developing chamber having a support portion pivotally supporting the developing roller and the supply roller;
a developing blade configured to regulate a layer thickness of toner on the developing roller;
toner including toner particles having a volume average particle size R and an external additive; and
a toner storage storing the toner,
the toner storage communicating with the developing chamber via a communication port,
a moving direction of a surface of the developing roller being opposite to a moving direction of a surface of the supply roller at a contact position with the supply roller,
in a cross section of the process cartridge in a plane perpendicular to a rotation shaft of the developing roller in an attached state of being attached to an apparatus main body of the image forming apparatus, a portion where the developing blade comes into contact with the developing roller being vertically below a horizontal line H1 passing through a rotation shaft center of the developing roller,
the process cartridge further comprising:
a driving force receiving portion;
a first driving force transmitting portion configured to transmit a driving force from the driving force receiving portion to the supply roller;
a second driving force transmitting portion disposed in the supply roller and configured to transmit a driving force received by the first driving force transmitting portion to the developing roller; and
a third driving force transmitting portion disposed in the developing roller and configured to transmit a driving force from the second driving force transmitting portion to the developing roller, wherein
the toner includes hydrotalcite particles as the external additive,
fluorine is present inside the hydrotalcite particles in line analysis in STEM-EDS mapping analysis of the toner,
the developing blade includes a plate-shaped metal elastic blade and a blade support portion supporting the elastic blade,
in a cross section of the process cartridge in a plane perpendicular to the rotation shaft of the developing roller,
the elastic blade forms a nip N1 with the developing roller and is in contact with the developing roller,
a point at an end portion on an upstream side in a rotation direction of the developing roller in the nip N1 on the elastic blade is defined as a point D,
a point which is closest to a free end side of the elastic blade and closest to a surface of the developing roller is defined as a point B,
a point where a perpendicular line extending from the point B to the surface of the developing roller intersects with the surface of the developing roller is defined as E,
there is a point F which is a point on a surface of the elastic blade whose distance from the surface of the developing roller is R and closest to the free end side of the elastic blade, and
when a point on a straight line BE at which a distance from the surface of the developing roller is R is defined as G, a distance of GF is R or more.

2. A process cartridge attachable to an image forming apparatus, comprising:
a photosensitive drum which is an image carrier; a developing roller configured to develop a toner image on the photosensitive drum;
a supply roller configured to supply toner to the developing roller;
a developing chamber having a support portion pivotally supporting the developing roller and the supply roller;
a developing blade configured to regulate a layer thickness of toner on the developing roller;
toner including toner particles having a volume average particle size R and an external additive; and
a toner storage storing the toner,
the toner storage communicating with the developing chamber via a communication port,
a moving direction of a surface of the developing roller being opposite to a moving direction of a surface of the supply roller at a contact position with the supply roller,
the developing blade including a plate-shaped metal elastic blade and a blade support portion supporting the elastic blade,
in a cross section of the process cartridge in a plane perpendicular to a rotation shaft of the developing roller,
in a posture in which a straight line A connecting rotation centers of the supply roller and the developing roller is inclined by about 9.85° from horizontal, a rotation shaft center of the supply roller is located below a rotation shaft center of the developing roller, and a rotation shaft center of the photosensitive drum is located above the straight line A, a portion where the elastic blade comes into contact with the developing roller being located below the rotation shaft center of the developing roller,
the process cartridge further comprising:
a driving force receiving portion;
a first driving force transmitting portion configured to transmit a driving force from the driving force receiving portion to the supply roller;
a second driving force transmitting portion disposed in the supply roller and configured to transmit a driving force received by the first driving force transmitting portion to the developing roller; and
a third driving force transmitting portion disposed in the developing roller and configured to transmit a driving force from the second driving force transmitting portion to the developing roller, wherein
the toner includes hydrotalcite particles as the external additive,
fluorine is present inside the hydrotalcite particles in line analysis in STEM-EDS mapping analysis of the toner,
in a cross section of the process cartridge in a plane perpendicular to the rotation shaft of the developing roller,
the elastic blade forms a nip N1 with the developing roller and is in contact with the developing roller,
a point at an end portion on an upstream side in a rotation direction of the developing roller in the nip N1 on the elastic blade is defined as a point D,
a point which is closest to a free end side of the elastic blade and closest to a surface of the developing roller is defined as a point B,
a point where a perpendicular line extending from the point B to the surface of the developing roller intersects with the surface of the developing roller is defined as E,
there is a point F which is a point on a surface of the elastic blade whose distance from the surface of the developing roller is R and closest to the free end side of the elastic blade, and
when a point on a straight line BE at which a distance from the surface of the developing roller is R is defined as G, a distance of GF is R or more.

3. The process cartridge according to claim 1, wherein
when a tangent line at a point F on the surface of the elastic blade is defined as a straight line L4, an angle θ formed by the straight line L4 and a straight line DE is in a range of 0°<θ<45°.

4. The process cartridge according to claim 3, wherein
the angle θ is in a range of 0°<θ<25°.

5. The process cartridge according to claim 1, wherein
a distance between any point on the elastic blade from the point D to the point B and the surface of the developing roller increases as a distance from the point D increases.

6. The process cartridge according to claim 1, wherein
a distance of the FG is 20 μm or more.

7. The process cartridge according to claim 1, comprising
a second driving force receiving portion configured to transmit a driving force to at least the photosensitive drum.

8. The process cartridge according to claim 1, wherein
the developing roller and the supply roller are driven and connected to each other by a driving force from the driving force receiving portion so as to rotate such that a peripheral speed ratio R represented by the following formula (E1) satisfies R>1.0,
$$R = Vrs / Vd \qquad ( E 1 )$$
in which Vrs represents an absolute value [mm/sec] of a peripheral speed of the supply roller, and Vd represents an absolute value [mm/sec] of a peripheral speed of the developing roller.

9. The process cartridge according to claim 1, wherein
when a radius of the developing roller is represented by Rd [mm] and a radius of the supply roller is represented by Rrs [mm],
the second driving force transmitting portion and the third driving force transmitting portion are driven and connected to each other such that a rotational angular velocity ratio λ expressed by the following formula (E2) satisfies λ×Rrs/Rd>1.0,
$$λ = ω rs / ω d \qquad ( E 2 )$$
in which ωrs represents a rotational angular velocity [rad/sec] of the supply roller, and ωd represents a rotational angular velocity [rad/sec] of the developing roller.

10. The process cartridge according to claim 1, wherein
a stirring member configured to stir toner is not present in the developing chamber.

11. The process cartridge according to claim 1, wherein
among members supported by the developing chamber, only the developing roller and the supply roller are supported so as to be able to transmit a driving force from the driving force receiving portion.

12. The process cartridge according to claim 1, wherein
the elastic blade is supported so as to have flexibility between a support end supported by the blade support portion and the other free end in an attached state of being attached to an apparatus main body of the image forming apparatus, and
when a horizontal line passing through the support end is represented by a straight line H2, at least a part of an inner wall of a developing chamber which is between two tangent lines extending in a vertical direction among tangent lines in contact with an outer peripheral surface of the supply roller and is below the supply roller in the vertical direction is above the straight line H2 in the vertical direction.

13. The process cartridge according to claim 1, comprising
a conveying member configured to convey toner, wherein
the conveying member is a member that has elasticity and conveys the toner by being rotated, and
the conveying member is rotatably and pivotally supported in the toner storing chamber.

14. The process cartridge according to claim 13, wherein
in an attached state of being attached to an apparatus main body of the image forming apparatus,
the communication port is formed above the toner storage,
the conveying member is a member that has elasticity and conveys the toner by being rotated,
the process cartridge comprises:
a deformation portion disposed in the toner storage so as to be in contact with a free end side of the conveying member at a position on an upstream side in a rotation direction of the conveying member with respect to the communication port, the deformation portion deforming the conveying member against the elasticity with rotation of the conveying member such that the free end side is on an upstream side in the rotation direction of the conveying member with respect to a rotation shaft side; and
a restoration portion that is disposed in the toner storage such that a distal end on a free end side of the conveying member is released from contact at a position on a downstream side of the conveying member in a rotation direction with respect to the deformation portion and on an upstream side of the conveying member in the rotation direction with respect to the communication port, the restoration portion restoring the conveying member deformed by the deformation portion by the elasticity in order to cause the toner on the conveying member to fly to the communication port,
in the attached state, a boundary portion between the deformation portion and the restoration portion is located below a lower end of the communication port,
a rotation center of the conveying member and a rotation center of the developing roller are on the same side with respect to a vertical line passing through the boundary portion when viewed from an axial direction of the developing roller, and
a maximum value of a rotation radius of the conveying member is larger than a distance between the rotation center of the conveying member and a lower end of the communication port.

15. The process cartridge according to claim 13, wherein
the conveying member includes a rotation shaft and a flexible sheet member fixed to the rotation shaft, and
the sheet member is fixed to a plurality of different phases around a stirring shaft.

16. The process cartridge according to claim 1, wherein
in the elastic blade,
a distal end shape including the point D is formed by polishing a surface of the elastic blade.

17. The process cartridge according to claim 1, wherein
in the elastic blade,
a distal end shape including the point D is formed by bending a distal end of a plate-shaped elastic member made of metal in a direction opposite to a contact surface side of the developing roller.

18. The process cartridge according to claim 1, wherein
fluorine and aluminum are present inside the hydrotalcite particles in line analysis in STEM-EDS mapping analysis of the toner, and
a value of a ratio (F/Al) of an atomic number concentration (atomic %) of the fluorine to an atomic number concentration (atomic %) of the aluminum in the hydrotalcite particles, obtained from principal component mapping of the hydrotalcite particles by STEM-EDS mapping analysis of the toner is 0.01 to 0.65.

19. The process cartridge according to claim 1, wherein
a fixation ratio of the hydrotalcite particles to the toner particles is 10% or more.

20. The process cartridge according to claim 1, wherein
the hydrotalcite particles contain magnesium.

21. The process cartridge according to claim 20, wherein
a value of a ratio (Mg/Al) of an atomic number concentration (atomic %) of the magnesium to an atomic number concentration (atomic %) of aluminum in the hydrotalcite particles is 1.5 to 4.0.

22. The process cartridge according to claim 1, wherein
a number average particle size of primary particles of the hydrotalcite particles is 60 to 1000 nm.
